(19) United States
(12) Patent Application Publication
(10) Pub. No.: US 2026/0253029 A1
(43) Pub. Date: Aug. 27, 2026

(54) A SYSTEM AND METHOD FOR OPTIMIZATION OF A ROBOTIC AUTOMATED WAREHOUSE AND A TASK MANAGER SYSTEM THEREOF

(71) Applicant: Caja Elastic Dynamic Solutions Ltd, Binyamina (IL)

(72) Inventors: Yaroslav GOLDIN, Bahan (IL); Ilan COHEN, Salit (IL); Henri GARIH, Binyamina (IL)

(21) Appl. No.: 18/874,720

(22) PCT Filed: Jun. 13, 2023
(86) PCT No.: PCT/IL2023/050608

§ 371 Date: Dec. 13, 2024

(30) Foreign Application Priority Data
Jun. 13, 2022 (IL) 293899
Aug. 8, 2022 (IL) 295460

(51) Int. Cl. G06Q 10/087; B65G 1/137; G06Q 10/047; G06Q 10/067; G06Q 10/20

(52) U.S. Cl. CPC G06Q 10/08726; B65G 1/1373; G06Q 10/047; G06Q 10/0674; G06Q 10/08743; G06Q 10/20

(57) ABSTRACT

The present disclosure relates to a task manager technique being capable of performing algorithms providing to an operator, in real-time or in a predicted manner, a recommendation optimization data regarding an optimization of a warehouse with respect to optimal resources (e.g. number of picker persons, allocation of tasks to picker persons when not be dedicated at the station, number of “open” picking stations and number of robots . . . ) to be deployed at each period of time in the actual day/week/month or as anticipation for future days/weeks/months as well. The present disclosure also relates to a novel optimization system for use in warehouses capable of inter alia controlling/managing a plurality of independent management modules.

This application is a U.S. National Stage Application under 35 U.S.C § 371 of International Patent Application No. PCT/IL2023/050608 filed Jun. 13, 2023, which claims the benefit of priority under 35 U.S.C. § 119 to Israeli Patent Application No. 293899 filed Jun. 13, 2022 and Israeli Patent Application No. 295460 filed Aug. 8, 2022, the disclosures of all of which are hereby incorporated by reference in their entireties.

### TECHNOLOGICAL FIELD

Embodiments of the presently disclosed relate generally to warehouse management systems and more specifically to systems and methods for optimization of a robotic automated warehouse and for task management.

### BACKGROUND

Warehouses and storage centers, for example, ones that facilitate e-commerce orders commonly use manual or semi-manual processes to perform order fulfillment processes, which are performed once an order is received. Some systems are based on operators standing in the picking area while boxes are moving, and others create complex rack structures for space utilization. Some solutions utilize mobile robots to fetch cases and bins to a picking area. Moreover, order fulfillment of orders must take place within a relatively short period of time to be commercially competitive. Such order fulfillment is known as E-commerce and places demands on an order fulfillment system to meet such obligations. Each unique item has a specific inventory identification, known in the industry as a stock-keeping unit (SKU). Each item usually bears an optical code, such as a barcode or radio frequency identification (RFID) tag that identifies the SKU of the item. Picking stations in automated warehouses work in a way that the box arrives (by a robot or a conveyor or any other means) from storage to a particular station, the picker (human or robotic), picks from the specific box, one or several items, and places the items on a put wall so that packers can package the one or more items to provide one or more packages that are outputted from the automated warehouse, alternatively, in some cases, the packages are picked by their SKU and a sorter (human or automated) can sort the SKUs into orders for packer(s) to pack them. The box awaits until the picker picks one or several items and then returns the box to storage.

Warehouse optimization is key to the efficient operation of warehouses of all sizes. Warehouse optimization enables determining how to save time, space, and resources while reducing errors and improving flexibility, communication, management, and customer satisfaction. An automated warehouse may be managed by an automated warehouse control system (WCS) being configured and operable to perform automated warehouse control and management operations. Warehouse optimization systems may be a part of the WCS or may be different modules being used to optimize warehouse flow, product placement (i.e., storing of goods), space utilization, efficient use of workforce and robots, sales prediction, etc.

### GENERAL DESCRIPTION

Order fulfilment of orders must take place within a relatively short period of time in order to be commercially competitive. The warehouse usually has a number of predefined resources including a predefined number of picking stations being associated with a certain number of picker persons usually working a predefined number of shift working hours and a predefined number of robots. Generally, the predefined resources are attributed arbitrarily according to the averaged orders received during a certain period or according to the size of the warehouse affecting the number of picking stations. However, it should be noted that if the orders are not fulfilled on time, the picker persons may work overtime, maintenance tasks may be postponed, or even worse, the delivery time may be delayed. On the contrary, if the number of orders does not correspond to the predefined resources, some picking stations may be closed, and the time of the picker persons may be wasted.

Moreover, in the order fulfillment processes, special events (order triggering events) can accelerate the sales of specific items. For example, certain seasons may accelerate the sales of certain types of food and/or items for cooking such foods (turkeys before thanksgiving, grills and/or barbeque equipment at the beginning of spring), rain and/or snow can accelerate the sales of umbrellas and/or raincoats and/or boots, the beginning of summer may accelerate the sales of bathing suits and/or sunscreens and/or sun glasses, holidays may accelerate the sales of certain items such as Christmas ornament every Decembers, flowers on Valentine's day or costumes before Halloween. Therefore, the need for resources (e.g. number of picker persons, allocation of tasks to picker persons when not be dedicated at the picking station, number of “open” picking stations and number of robots . . . ) is not uniform throughout the year. More specifically, some periods of the year may require a certain number of picker persons working every day in a full-time position and some periods of the year (that might be very short) may require to double the number of picker persons and to extend the picking hours to be able to match the delivery time. Therefore, there is a need to forecast an optimal execution of the operational tasks of an automated warehouse, to optimize the resources of a warehouse management system to be able to manage or predict the trends in demand in general, and on specific items in particular, for example based on the past, e.g. an item is demanded every Friday, every 1st of the month, every Christmas, especially at peak times-such as black Friday, cyber-Monday or Christmas, i.e. the months of November and December to be able to meet the operator's needs.

The presently disclosed subject matter relates to a task manager system being capable of performing algorithms providing to an operator, in real-time or in a predicted manner, a recommendation optimization data regarding an optimization of a warehouse with respect to optimal resources (e.g. number of picker persons, allocation of tasks to picker persons when not be dedicated at the station, number of “open” picking stations and number of robots . . . ) to be deployed at each period of time in the actual day/week/month or as anticipation for future days/weeks/months as well. The optimization data may include at least one of the followings: number of picking stations that should be actuated, number of actuated robots of each type, optimal time of operation of the picking stations, managing time of the picker persons, and also optimization data regarding maintenance tasks such as managing the inventory, filing the stock, optimal location of selected items before or after the pick-up . . . .

The term “optimally attributed” refers hereinafter to the ideal allocation and utilization of various resources of the warehouse to be deployed at each period of time in the actual day/week/month or as anticipation for future days/weeks/months as well, in order to complete at least one optimization task or performing in the selected time period at least one maintenance task.

The present disclosure enables to forecast an optimal execution of the operational tasks of an automated warehouse for a predetermined period of time at which the preparation of orders to be prepared using items from the warehouse should be completed, to optimize the resources of a warehouse management system and to provide to the operator the optimized time to perform maintenance tasks. It should be understood that if the orders are not fulfilled on time, the picker persons may work overtime, maintenance tasks may be postponed, or even worse, the delivery time may be delayed. Moreover, it should be noted that when the operator of the automated warehouse attributes the number of resources arbitrary, the operator is not able to evaluate the consequences of the different attributions of resources and/or tasks on the system throughput. Moreover, the operator is not capable of calculating the time at which the tasks would be completed. Additionally, the operator is also not capable of deciding when maintenance tasks should be done, if any. The present disclosure provides a recommendation optimization data advising on the optimal resources (e.g. number of picking stations that should be opened and time to fulfill the replenishment together with the pick-up). The task manager system receives from the operator and/or from a database at least one maintenance task to be performed in the warehouse. The database is thus configured and operable to store at least one maintenance task (as a function of certain period of time, or not) as well as their respective parameters. The operator can input manually a list of maintenance tasks to be performed for the warehouse's specific needs (for a predetermined period of time, or not) into the task manager system. Additionally or alternatively, the operator can access the database and select from the database at least one maintenance task to be performed in the warehouse (for a predetermined period of time or not). Additionally or alternatively, the database may automatically input to the task manager system at least one maintenance task to be performed automatically (for a predetermined period of time or not). The simulations enable the operator to understand the effect of the attribution of the different number of resources. Moreover, the operator may also be able to control and change in real-time or by anticipation the different attributions of the resources of the system. For example, more or less picking stations may be opened or closed, more or less robots of the same or different types may be used . . . . For example, new picking stations may be opened if the number of orders that has been received exceeds the forecast. If the operator decides to perform maintenance tasks together with the picking up of the orders, he may define several maintenance tasks parameters such as a certain number of boxes/items to replenish, a number of cycle count that should be proceeded with, a number of consolidation and/or recall tasks, to obtain the number of picker persons required to accomplish these tasks. This enables to calibrate the operation of the warehouse to the operator's needs.

The computerized task manager system has input and output data utilities. The processing includes the step of performing a plurality of simulations, generating a recommendation optimization data and attributing optimal resources. The mode of operation of the processing may be automatic or manual as defined by the operator. The processing steps may be performed sequentially in an automatic manner or may be performed manually upon input of the operator. The selection of the optimization parameters including the allocation of at least one maintenance task is not a known process. Moreover, as mentioned above, the recommendation optimization data provided by the task manager system of the present disclosure enables to control and change in real-time or by anticipation the different attributions of the resources of the warehouse, to thereby calibrate the operation of the warehouse to the operator's needs. The simulations enable the operator to understand the effect of the attribution of the different number of resources. Therefore, the processing being implemented by the task manager of the present disclosure provides much more than a “standard processing recommendation” since no algorithm is capable of providing different attributions of the resources of the warehouse considering maintenance tasks.

Therefore, as described above, according to one broad aspect of the present disclosure, there is provided a task manager system for a warehouse comprising a processor being configured and operable for receiving (i) at least one maintenance task to be performed in the warehouse, wherein the at least one maintenance task comprises at least one of replenishment, consolidation, cycle count, space reduction, warehouse maintenance, recall or replacement of batteries; (ii) a time data being indicative of a predetermined period of time at which the preparation of orders to be prepared using items from the warehouse should be completed, and (iii) warehouse resources to be attributed in the predetermined period of time including at least one of a predefined number of picking stations being associated with a certain number of picker persons and a predefined number of robots; processing the time data, by performing a plurality of simulations on a plurality of optimization parameters for the given time data, and generating a simulation data including a plurality of sets of optimization parameters, wherein the sets of optimization parameters include the warehouse resources and allocation of at least one maintenance task; determining a selected set of optimization parameters based on the simulation data including the allocation of at least one maintenance task to be completed together with the preparation of the orders and an optimized attribution of the resources of the warehouse to thereby generate a recommendation optimization data for the predetermined period of time comprising a plurality of optimization parameters being indicative of optimal resources that should be optimally attributed to complete at least one task including at least one maintenance task.

In some embodiments, the task manager system comprises an input data utility being configured and operable for receiving (i) at least one maintenance task to be performed in the warehouse, wherein the at least one maintenance task comprises at least one of replenishment, consolidation, cycle count, space reduction, warehouse maintenance, recall or replacement of batteries; (ii) a time data being indicative of a predetermined period of time at which the preparation of orders to be prepared using items from the warehouse should be completed and (iii) warehouse resources to be attributed in the predetermined period of time including at least one of a predefined number of picking stations being associated with a certain number of picker persons and a predefined number of robots, an output data utility being configured and operable for provide an optimization data; and, a processor being configured and operable for: processing the time data by performing a plurality of simulations on a plurality of the optimization parameters, wherein the plurality of optimization parameters comprises at least one of predicted optimized number of robots of each type that should be actuated, predicted optimized number of picker persons, predicted optimized number of picking stations and allocation of at least one maintenance task to at least one picker person when not be dedicated at the station; wherein the at least one maintenance task comprises at least one of replenishment, consolidation, cycle count, space reduction, warehouse maintenance, recall or replacement of batteries; selecting one simulation from the plurality of simulations to determine the optimal set of optimization parameters by attributing optimal resources to complete at least one task including at least one maintenance task, wherein the optimal resources include at least one of (i) a predefined number of picking stations being associated with a certain number of picker persons working usually a predefined number of shift working hours and (ii) a predefined number of robots, determining a recommendation optimization data for the predetermined period of time to thereby generate a recommendation optimization data regarding an optimization of a warehouse wherein the recommendation optimization data comprises the plurality of optimization parameters. Wherein when the optimization data is generated before the preparation of the orders, the recommendation optimization data further comprises data being indicative of at least one of the followings: optimal location of selected items before or after pick-up, optimal time of operation of picking stations before and/or during the preparation of the orders, managing time of picker persons, wherein the recommendation optimization data enables to control and change in real-time or by anticipation the different attributions of the resources of the warehouse, to thereby calibrate the operation of the warehouse to the operator's needs.

In some embodiments, the selected set of optimization parameters further comprises at least one maintenance task parameter, wherein said at least one maintenance task parameter comprises at least one of a certain number of at least one of box and item to replenish, a number of cycle count, a number of consolidation and/or recall task. In some embodiments, the processor is configured and operable for receiving order data being indicative of the orders to be prepared using items from the warehouse, wherein generating a recommendation optimization data comprising a plurality of optimization parameters being indicative of optimal resources that should be optimally attributed to complete at least one task including at least one of completion of the preparation of the orders and at least one maintenance task. The order data may comprise at least one order line or recall data. Each order line may comprise at least one order related parameter including an item identifier, a due date data for supplying the item and a quantity. The due date data may comprise an expected delivery due date and/or an indication for prioritized handling.

In this connection, it should be noted that, typically, the purpose of an automatic warehouse is to fulfill orders. However, the ordering can be suspended at a certain period of time (e.g. at the company yearly report time when cycle count should be performed on every item). The robots should then bring every box to the picking station(s) to perform the cycle count. The task manager of the present disclosure can then provide a forecast of time/picking stations/robots needed for the operation. Also, days before a special event, the number of orders can drop to zero, since customers wait for these events to order items. Thus, at this time, the warehouse workers can prepare the special events operation by performing at least one maintenance task such as consolidating, recalling and replenishing inventory as will be detailed further below.

In some embodiments, the optimization of a warehouse may include a special planning in real-time of the warehouse (e.g. location of the items) according to the orders (amount and/or type of items) or to the predicted orders being related to special events. The optimization of a warehouse may also include planning an optimized organization of the warehouse before the special events. The recommendation optimization data may take into consideration the orders or the predicted orders.

In some embodiments, the optimization of a warehouse may include optimizing the number of actuated robots according to the maintenance data of the robots and/or of the movement data of the robots in the warehouse and/or data relating to the size of the warehouse and the distance/time of the round trip.

In some embodiments, the processor is configured and operable for receiving historical data being indicative picking parameters including averaged picked-up time.

The optimization of a warehouse may thus include providing recommendation optimization data based on historical data including averaged picked-up time.

In some embodiments, the recommendation optimization data comprises a plurality of options, each option being indicative of a different optimization of the plurality of the optimization parameters.

In some embodiments, the plurality of optimization parameters comprises at least one of predicted optimized number of robots of each type that should be actuated, predicted optimized number of picker persons, predicted optimized number of picking stations and allocation of at least one maintenance task to at least one picker person when not be dedicated at the station. The maintenance task may comprise replenishment and/or consolidation and/or cycle count and/or space reduction and/or warehouse maintenance and/or recall and/or replacement of batteries.

In some embodiments, processing the time data (and optionally order data) comprises performing a plurality of simulations on the plurality of the optimization parameters. The order data may be received from a customer management system and the time data may be received from an operator, the customer management system and the operator being in data communication of the processor.

In some embodiments, generating the recommendation optimization data comprises generating the recommendation optimization data before the preparation of the orders including the day at which the orders are prepared or at least one day before the preparation of the orders or in real-time during the preparation of the orders.

In some embodiments, when the recommendation optimization data is generated before the preparation of the orders, the recommendation optimization data comprises data being indicative of at least one of the followings: optimal location of selected items before or after pick-up, optimal time of operation of picking stations before and/or during the preparation of the orders, managing time of picker persons.

In some embodiments, the order data comprises predicting data being indicative of at least one of predicted orders enabling to provide a recommendation optimization data being related to special events. The predicting data may be based on historical data predicting the special events.

According to one broad aspect of the present disclosure, there is provided a method for optimizing warehouse management. The method comprising obtaining, by at least one computerized system, (i) at least one maintenance task to be performed in the warehouse, wherein the at least one maintenance task comprises at least one of replenishment, consolidation, cycle count, space reduction, warehouse maintenance, recall or replacement of batteries; (ii) a time data being indicative of a predetermined period of time at which the preparation of the commanded orders should be completed and (iii) warehouse resources to be attributed in the predetermined period of time including at least one of (i) a predefined number of picking stations; (ii) a number of human pickers associated with each of the predefined stations; and (iii) a predefined number of robots, generating a plurality of optimization parameters comprising the warehouse resources and allocation of at least one maintenance task, the generating comprising performing a plurality of simulations using different resource attribution parameters; determining a selected set of optimization parameters based on the simulation data, the selected set of optimization parameters including (i) the allocation of at least one maintenance task to be completed together with the preparation of the orders and (ii) an optimized attribution of the resources of the warehouse, to thereby generate a recommendation optimization data for the predetermined period of time comprising a plurality of optimization parameters being indicative of optimal resources that should be optimally attributed to complete at least one task including at least one of completion of the preparation of the orders and at least one maintenance task.

In some embodiments, the method comprises obtaining, by at least one computerized system, a time data being indicative of a predetermined period of time at which the preparation of the orders should be completed, processing the time data, and generating a recommendation optimization data regarding an optimization of a warehouse including an optimization data for the predetermined period of time comprising a plurality of optimization parameters being indicative of optimal resources that should be attributed to complete at least one task including at least one of completion of the preparation of the orders and at least one maintenance task, wherein processing the time data comprises performing a plurality of simulations on the plurality of the optimization parameters, wherein, when the optimization data is generated before the preparation of the orders. The optimization data comprises data being indicative of at least one of the followings: optimal location of selected items before or after pick-up, optimal time of operation of picking stations before and/or during the preparation of the orders, managing time of picker persons, wherein the plurality of optimization parameters comprises at least one of predicted optimized number of robots of each type that should be actuated, predicted optimized number of picker persons, predicted optimized number of picking stations and allocation of at least one maintenance task to at least one picker person when not be dedicated at the station, wherein the optimal resources includes at least one of (i) a predefined number of picking stations being associated with a certain number of picker persons working usually a predefined number of shift working hours and (ii) a predefined number of robots, wherein the at least one maintenance task comprises at least one of replenishment, consolidation, cycle count, space reduction, warehouse maintenance, recall or replacement of batteries, wherein the recommendation optimization data enables to control and change in real-time or by anticipation the different attributions of the resources of the warehouse, to thereby calibrate the operation of the warehouse to the operator's needs.

In some embodiments, the method further comprises receiving together with the time data, an order data being indicative of orders to be prepared using items from the warehouse and wherein generating a recommendation optimization data comprising a plurality of optimization parameters being indicative of optimal resources that should be optimally attributed to complete at least one task including at least one of completion of the preparation of the orders and at least one maintenance task.

In some embodiments, the method further comprises receiving historical data being indicative picking parameters including averaged picked-up time.

In some embodiments, the method further comprises receiving a predicting data being indicative of at least one of predicted orders enabling to provide a recommendation optimization data being related to special events.

According to one broad aspect of the present disclosure, there is provided at least one non-transitory computer readable medium that stores instructions that once executed by a computerized system causes the computerized system to execute a process for optimizing a warehouse management, the non-transitory computer readable medium stores instructions for: obtaining, by at least one computerized system, a time data being indicative of a predetermined period of time at which the preparation of the orders should be completed, processing the time data, and generating a recommendation optimization data for the predetermined period of time comprising a plurality of optimization parameters being indicative of optimal resources that should be optimally attributed to complete at least one task including at least one maintenance task. The processing of the time data may comprise performing a plurality of simulations on the plurality of the optimization parameters. When the recommendation optimization data is generated before the preparation of the orders, the recommendation optimization data may comprise data being indicative of at least one of the followings: optimal location of selected items before or after pick-up, optimal time of operation of picking stations before and/or during the preparation of the orders, managing time of picker persons. The plurality of optimization parameters may comprise at least one of predicted optimized number of robots of each type that should be actuated, predicted optimized number of picker persons, predicted optimized number of picking stations and allocation of at least one maintenance task to at least one picker person when not be dedicated at the station. The optimal resources may include at least one of (i) a predefined number of picking stations being associated with a certain number of picker persons working usually a predefined number of shift working hours and (ii) a predefined number of robots, wherein the at least one maintenance task comprises at least one of replenishment, consolidation, cycle count, space reduction, warehouse maintenance, recall or replacement of batteries.

According to one broad aspect of the present disclosure, there is provided an automated warehouse that comprises: a storage configured to store multiple items, wherein the multiple items are stored in item containers; a plurality of picking stations that comprise at least one picking station; one or more robots that are configured to convey item containers to the plurality of picking stations; and a task manager system as defined above.

Current optimization systems are independent systems and as such, each system provides optimization of a certain predefined one or more processes in the warehouse without integrating the output/recommendations of other independent optimization systems in the warehouse. This can lead to sub-optimal results at the decision level but will not improve the overall performance of the warehouse.

There is a need in the art for a novel optimization system capable of providing an additional optimization level/layer (i.e., multi-level) on top of the optimizations provided by the independent optimization systems in the warehouse in order to optimize various operational tasks/processes in warehouses and warehousing functions as well as utilizing warehouse space as efficiently (e.g., storing a maximal number of items/item containers) as possible to thereby maximize the number of orders that can be fulfilled in a given period of time while also enabling a cost-effective warehouse operation and management. Typically, order fulfillment must take place within a relatively short period of time in order to be commercially competitive.

The present disclosure relates to a novel optimization system for use in warehouses being capable of controlling/managing a plurality of independent management modules, providing (i) prioritization between the different independent management modules and (ii) an optimal operation of each module in order to enable a maximal number of orders to be executed/prepared per a selected time period (e.g., day or week) and/or performing in the selected time period at least one maintenance task and/or maximum storage density in the warehouse by at least one of consolidation of boxes or emptying boxes as well as optionally managing the inbound and the inventory (i.e., cycle count/inventory validation) to minimize the stored items that are on record of the WCS/WMS and the actual sorted items. The term “optimal operation” refers hereinafter to the condition in which each management module functions or performs at its highest level of efficiency, effectiveness, or desired outcome. It represents the ideal or best-performing state that is achieved by optimizing various factors, parameters, or variables involved in each management module. Optimal operation involves maximizing the desired outputs or objectives while minimizing resource consumption, costs, or other constraints. It typically requires balancing different factors, trade-offs, or variables to achieve the most favorable outcome. Optimal operation is achieved through the application of optimization techniques, such as mathematical modeling, algorithms, or simulation, which enable the identification and selection of the best configuration, parameters, or decisions for each management module.

Therefore, according to one broad aspect of the present disclosure, there is provided an optimization system for use in automatic warehouses comprising a processing unit being configured and operable to control a plurality of independent management modules, providing prioritization between the independent management modules and an optimal operation of each management module in order to enable at least one of: maximal number of orders to be prepared per the selected time period, performing in the selected time period at least one maintenance task. The term “maintenance task” refers hereinafter to a specific activity performed to ensure the proper functioning, reliability, and longevity of the robotic automated warehouse. Maintenance can include routine inspections, cleaning, lubrication, calibration, repairs, replacements, and other activities aimed at preserving or restoring the optimal performance and functionality of the robotic automated warehouse. The purpose of maintenance tasks is to identify and address any potential or existing problems, minimize downtime, extend the lifespan of the robotic automated warehouse, and ensure that it continues to operate safely and efficiently. Maintenance tasks are crucial for preventing equipment failures, reducing risks, and maintaining the operational integrity of the robotic automated warehouse, thereby contributing to the overall reliability and productivity of the robotic automated warehouse.

In some embodiments, the optimization system comprises a plurality of independent management modules, wherein each management module is configured and operable to manage different warehouse tasks including at least one of items location or one or more optimization tasks, and to generate a recommendation optimization data including an optimization data for a selected period of time comprising a plurality of optimization parameters. The term “optimization task” refers hereinafter to any task to be performed in the robotic automatic warehouse that should be optimized by utilizing mathematical or computational techniques to find the best possible solution or configuration that optimizes the desired task within given constraints. It may include any one of maintenance task, order management, inventory management, mission planning, robot navigation, and task management or any combination thereof.

The term “recommendation optimization data” refers hereinafter to a suggestion given by at least one management module to an operator to maximize the management of the warehouse and provides the optimization parameters for a predetermined period of time. The optimization parameters may include optimized time to perform maintenance tasks and/or prioritization between the plurality of tasks to be performed and/or an optimal route/path for the at least one robot from the starting/initial location of the robot location to the destined/intended location and/or the recommended speed at which each robot should be operated and/or advising on the optimal resources and/or optimal location data (e.g., proximity to a picking station and height from the ground) indicative of a specific location at which the at least one item container is to be positioned etc. The optimization parameters mentioned above are just possible examples. However, the present disclosure is not limited to such examples. Other examples are also described further below.

The term “optimization parameters”” refers hereinafter to parameters of the robotic automated warehouse that can be adjusted or manipulated in the process of optimizing the robotic automated warehouse or achieving a desired outcome to enhance the performance, efficiency, or effectiveness of the robotic automated warehouse. They may include at least one of the following: optimal resources that should be optimally attributed to complete at least one optimization task (e.g. at least one of predicted optimized number of robots of each type that should be actuated, predicted optimized number of picker persons, predicted optimized number of picking stations and allocation of at least one maintenance task to at least one picker person when not be dedicated at the station) and/or the recommended speed at which each robot should be operated and/or the optimal path through which the robot can access a maximum number of items to be picked up etc. . . .

The term “optimal resources” refers hereinafter to the ideal allocation and utilization of various resources of the warehouse to be deployed at each period of time in the actual day/week/month or as anticipation for future days/weeks/months as well, in order to achieve the highest level of efficiency, productivity, and desired outcomes i.e. to complete at least one task including at least one of completion of the preparation of the orders and at least one maintenance task. It involves attributing the warehouse resources in a manner that maximizes output. Optimal resource utilization considers factors such as availability, capacity, and timing, to ensure that resources are utilized to their fullest potential, contributing to overall organizational success and goal attainment. The resources include the number of picker persons, the number of “open” picking stations and the number of robots. The recommendation optimization data advising on the optimal resources may include for example the allocation of tasks to picker persons when not be dedicated at the station, the number of picking stations that should be opened or the time to fulfill the replenishment together with the pick-up.

Each management module is a stand-alone module configured for performing different warehouse tasks. Each management module of the present disclosure is capable of optimizing its dedicated warehouse task. The management modules may include at least one of: a robot navigation management module, an order management module, an inventory management module, a location management module, and/or a task management module as will be detailed further below.

In some embodiments, the processing unit is configured and operable to receive the recommendation optimization data generated by each independent management module to selectively operate one or more of the independent management modules, to optimize the timing of the different warehouse tasks, and to provide an optimal recommendation optimization data for each independent management module taking into consideration the recommendation optimization data provided by the other management modules. The novel optimization system of the present disclosure is thus capable of using the recommendation optimization data provided by each of these independent management modules in order to (i) selectively operate one or more of the independent management systems, (ii) optimize at least a part of the different tasks in the warehouse simultaneously or sequentially and (iii) provide an optimal recommendation optimization data for each independent management module taking into consideration the recommendation optimization data of the other management optimization modules. The recommendation optimization data may be for present and/or near future and in some cases future tasks.

In some embodiments, the optimization system is capable of performing simulations based on which the optimization system selects which of the independent management modules is to be used. The plurality of simulations on the plurality of the optimization parameters may comprise applying different weights on each independent management module according to decisions to each one of them.

Additionally, or alternatively, the selective operation of one or more of the independent management systems may be carried out by properly implementing one or more optimization techniques/algorithms on the plurality of the optimization parameters. The optimization techniques include, inter alia, clustering optimization, classification, artificial intelligence (AI) techniques such as reinforcement machine learning, and/or deep reinforcement learning in combination with minimization of a cost function. Generally, in machine learning practices, a cost function may be defined as an indication of how well a machine learning model performs for a given dataset by calculating the difference between the expected output value and predicted output value and represents it as a single real number.

The automated warehouse includes storage for storing multiple item containers (e.g., boxes). The automated warehouse control system (WCS) may be executed by any type of computer: one or more servers, one or more computers, may be operated in a centralized or distributed manner. The WCS may include WCS parts that may manage different parts of the automated storage. The WCS may obtain (receive and/or generate) information relevant to the management of the automated warehouse. This may include at least one out of orders, received items, availability of trucks or any other output entities to output items from the automated warehouse, the content of item containers (items stored per box and/or quantity of items per box), a mapping between item identifiers (SKU, barcodes and the like) and items, locations of items (storage, picking stations), any information regarding an item (including item type, expiration period, storage parameter such as storage temperature, conveying parameter, fragility, the position of the activated robots, and the like), packaged boxes, the content of picking stations, historical data (including the history of orders), popularity information, environmental information, and the like. The historical data on SKUs may be calculated in the form of a trend on all the history of the SKU received by the WCS during a period of time starting from the installation of the warehouse management system. The WCS may be fed from sensors and/or any tracking systems and/or robots and/or picker persons about the locations of the item containers and the content of the item containers (including for example the amount of one or more items per box). The term ‘robot’ refers hereinafter to any mechanical or electro-mechanical agent that is guided by a computer program, electronic circuitry, or remote control. Sensors may be of any type-including visual sensors, cameras, RFID readers, NFC readers, and the like. The WCS is configured to manage the storage and/or provision process of the items. A process may include at least one out of picking an item container (including the item), providing the item container to a picking station, returning the item containers to the storage, managing the storage, performing the picking, and the like. When the picking is managed by a human then the WCS may provide suggestions regarding the picking. For example, the WCS may add received items to an overall inventory, allocate boxes for items, may fill or partially fill boxes by items, may add boxes to a box inventory, and the like. The WCS may be configured to determine the locations of boxes within the storage, for example by taking into account the distance to one or more picking stations and/or by taking into account the popularity of the items.

In this connection, it should be noted that the predetermined period of time may define any desired period of time including but not limited to any one of: part of a day, a single day, a plurality of days, an entire week, or even an entire month. The recommendation optimization data provides the optimization parameters for the predetermined period of time. During this period of time, the recommendation optimization data can provide sub-period of times during which the task to be performed relates only to order preparation and sub-period of times for maintenance tasks. Therefore, in some sub-periods of time, only orders can be prepared without processing with a maintenance task. For example, replenishment or consolidation or cycle count or replacing batteries, not be performed every day. The recommendation optimization data may provide the operator with the optimized time to perform maintenance tasks, so the throughput required for the order preparation is not impacted. As will be described further below, for example, the recommendation optimization data may recommend performing replenishment and/or consolidation tasks (e.g. the week before black Friday) because the load on picking is low and the inventory to fulfill the picking is needed during the next peak. The maintenance task may comprise replenishment and/or consolidation and/or cycle count and/or space reduction and/or warehouse maintenance and/or recall and/or replacement of batteries.

The replenishment task refers to a task during which a predefined number of new item containers are introduced into the WCS. The replenishment task requires picker person(s) and robot(s) resources. The new item containers are scanned at their specific location (i.e. specific storage casing in the warehouse and specific storage shelf on the storage casing). The replenishment data is entered in the WCS.

The consolidation task refers to a task during which the item containers i.e. boxes being partially filled are identified, and some items (usually having the same SKU as the other items being present in the item container) are displaced from one item container to another to completely fill the item containers and to thereby minimize the number of item containers in the system. The consolidation task requires picker person(s) to move the items from and to boxes and robot(s) resources to displace the boxes.

The cycle count refers to a task during which the number and optionally the type (being defined by the item identifier) of items in each item container is/are identified and correlated with the item data in the WCS/WMS, to verify that there are no discrepancies in the WCS/WMS.

The cycle count requires picker person(s) and robot(s) resources. For example, if a box has been brought to the picking station for picking purposes, and after the picking, the number of items is under a certain threshold, the system can recommend to the picker person to perform a cycle count. Alternatively, the cycle count can also be decorrelated from picking when the operator is required to perform a cycle count on a particular box or SKU not needed for picking and/or if there are no picking tasks that should be performed for a certain period of time, then the robots can bring the box/SKU to a counting station for cycle count.

Warehouse maintenance refers to at least one of cleaning the warehouse, inspecting the condition of the warehouse's equipment, verifying the operation of the robots, unloading item containers from a truck, etc. For example, the maintenance time of the robots, the time of swapping between the batteries, the charging time of their batteries if any, the waiting time on each robot path, as well as the time of a round trip for each robot according to the warehouse size may be considered. The space reduction task refers to a task during which the pick-up proceeds from multiple item containers for the same order line in order to empty the warehouse. In this connection, it should be noted that to efficiently operate the warehouse and increase the throughput all the storage units should be filled continuously to prevent the creation of empty space on the storage units. The space reduction task is time-consuming and may be generally implemented when no time constraint exists. The space reduction task requires picker person(s) and robot(s) resources.

In some embodiments, the plurality of independent management modules comprises at least two of the following modules: a mission planner management module, an order management module, an inventory management module, a robot navigation management module, and a task management module.

In some embodiments, the mission planner management module is configured and operable to receive task data being indicative of a plurality of tasks to be performed by one or more robots, processing the task data, and generating recommendation optimization data including prioritization between the plurality of tasks to be performed. The prioritization is being determined in accordance with the time/urgency/immediacy of at least some of the tasks to be performed. This may be implemented for example as described in the international patent publication No. WO 20/250101 assigned to the same assignee of the present disclosure.

In some embodiments, the robot navigation management module is configured and operable to determine the optimal path of each robot. The robot navigation management module is configured for receiving a request data indicative of a change of location of at least one robot including moving the robot from its initial location towards a destined/intended location at which a task is to be performed (e.g., to pick or remove an item or a maintenance task) in the warehouse and generating recommendation optimization data indicative of an optimal route/path for the at least one robot from the starting/initial location of the robot location to the destined/intended location, wherein the optimal route/path includes at least one of the fastest route, shortest route, and most energy efficient route. The request data may include additional constraints/parameters including, inter alia, time to leave, locations in which the robots may pass through etc.

This may be implemented for example as described in the international patent publication No. WO 20/250101 assigned to the same assignee of the present disclosure. For exampleevery robot may communicate with a computerized system that may be a central computing device which updates in real-time or near real-time to each robot the position of every object in the warehouse and provides the robot with routes. Alternatively, every robot may communicate with every other robot or the robots near it and adapt itself to the moving environment. The path of a robot may be recalculated according to any affected planned route of any robot according to various parameters-such as the location of one or more robots and/or other objects within the automated warehouse. Once a task is given to the robot, the robot or another entity may calculate the route (maybe the best path, a path that fulfills one or more constraints such as time, preventing from blocking another robot, and the like) to the actual destination. This route may be fixed or may be recalculated during progress (once, multiple times, or continuously) due to unforeseen events like the presence of a human in the pathway, or a blocking robot. The route calculating may include collision prevention for secure navigation in the warehouse. The navigation and/or recalculation of a path of progress may be based on the environment—for example, locations of other robots within the automated warehouse (or any part of the automated warehouse-such as near the robot, within the estimated path of the robot, and the like), location of one or more humans in the automated warehouse, (or any part of the automated warehouse-such as near the robot, within the estimated path of the robot, and the like), location of shelves or any other items within the automated warehouse (or any part of the automated warehouse-such as near the robot, within the estimated path of the robot, and the like), and the like. The robot navigation management module generates a recommendation optimization data for a selected period of time comprising a plurality of optimization parameters including the recommended speed at which each robot should be operated and the optimal path through which the robot can access a maximum number of items to be picked up. The optimal path can be the minimum distance that the robot should traverse.

In some embodiments, the optimal path of each robot is defined to maximize the number of items that can be picked up on the same path, even if the timing of the pick-up of such items is less urgent.

In some embodiments, the order management module is configured and operable for receiving order data being indicative of a plurality of orders to be prepared and for generating recommendation optimization data indicative of prioritizing item containers to be moved to one or more picking stations based in accordance prioritization between item containers to be moved to one or more picking stations based in accordance with a due time data with one or more predefined prioritization parameters. The due time data may include an expected delivery due date and/or an indication for prioritized handling. The predefined prioritization parameters can include time data being indicative of a predetermined period of time at which the preparation of orders to be prepared, boost (specific demand from the operator) of a given order (e.g., an unexpected order that needs to be fulfilled quickly), and commonality of one or more items. The orders may be obtained one after the other or in batches. An order may include an item identifier and one or more order-related parameters. An order-related parameter may include a due date for supplying the item and quantity. This may be implemented for example as described in the international patent publication No. WO 22/038579 assigned to the same assignee of the present disclosure.

In some embodiments, the inventory management module is configured and operable to determine the optimal location of the boxes (i.e. bins) in the storage. More specifically, the inventory management module is configured and operable for receiving at least one item container data and a warehouse map data being indicative of locations of each item container in a storage; processing the at least one item container data and the warehouse map data for generating a recommendation optimization data including an optimal location data being indicative of a specific optimal location at which the at least one item container is to be positioned on the storage. The optimal location data may be determined in accordance with one or more location optimization parameters including at least one of location history data of items, weather, and accordingly temperature at different locations in the warehouse, or discounts on items. The optimal location data may include data being indicative of at least one of a proximity to a picking station or a height from the ground. The warehouse map data may be continuously updated.

The automated warehouse includes a storage for storing multiple boxes. A storage may include one or more storage units. A storage unit may include one or multiple item containers that may be arranged in columns, in rows, in aisles, as a matrix, in an ordered manner, or in an unordered manner. The inventory management module is configured and operable to determine the optimal location for each box within the storage. This may be implemented for example as described in the international patent publication No. WO 22/038579 assigned to the same assignee of the present disclosure. For example, the location management module may be configured to determine the locations of boxes within the storage by considering the distance to one or more picking stations and/or by taking into account the popularity of the items. More specifically, the inventory management optimization module is configured for receiving and processing at least one item container data and warehouse map data informative of locations of all the stock (i.e., existing item containers) in the warehouse at a given point in time at which the at least one item container is to be placed/positioned in the warehouse for generating a recommendation optimization data including optimal location data (e.g., proximity to a picking station and height from the ground) indicative of a specific location at which the at least one item container is to be positioned. The warehouse map can be obtained from a database that can be a part of the optimization system or can be accessible by the system. The map is being updated by the system for each change in the locations of the stock (item containers) in the warehouse, i.e., each time an item container is moved from one place to another in the warehouse and/or each time a new item container is added/introduced to the warehouse (replenishment/inbound).

The optimal location can be determined in accordance with one or more location optimization parameters including, inter alia, location history data of items, weather and accordingly temperature at different locations in the warehouse, type of item (e.g., a detergent that cannot be stored above food items to avoid interaction of the detergent with the food items in case the detergent is spilled), and discounts on items.

As described above, there is provided a novel task management module/task manager system. The task management module/task manager system may be a part of the optimization system described above or may be an independent stand-alone module/system in data communication with the WCS. The terms “task management module” or “task manager system” are used hereinafter interchangeably. In some embodiments, the task management module is capable of performing algorithms providing to an operator, in real-time or in a predicted manner, a recommendation optimization data regarding optimization of a warehouse with respect to optimal resources (e.g. number of picker persons, allocation of tasks to picker persons when not be dedicated at the station, number of “open” picking stations and number of robots . . . ) to be deployed at each period of time in the actual day/week/month or as anticipation for future days/weeks/months as well.

In some embodiments, the optimization system is capable of performing simulations based on which the optimization system selects which of the independent management modules is to be used.

In some embodiments, the task management module is configured and operable for receiving a time data being indicative of a predetermined period of time at which the preparation of orders to be prepared using items from the warehouse should be completed, processing the time data, and generating a recommendation optimization data for the predetermined period of time comprising a plurality of optimization parameters being indicative of optimal resources that should be optimally attributed to complete at least one optimization task. The at least one maintenance task may include at least one of the following tasks: managing and replenishing an inventory, filing a stock, selecting an optimal location of selected items before or after pick-up, consolidating or emptying boxes to enable maximum storage density in the warehouse, recalling, cycle counting, reducing space, performing warehouse maintenance, or replacing batteries.

In some embodiments, the processing unit is configured and operable to selectively operate the independent management modules by applying one or more optimization algorithms on the plurality of the optimization parameters. Applying the one or more optimization algorithms may include performing a plurality of simulations on the plurality of the optimization parameters.

In some embodiments, performing a plurality of simulations on the plurality of the optimization parameters comprises applying different weights on each independent management module.

In some embodiments, the processing unit is configured and operable to divide the selected time period into a plurality of sub-time periods, wherein applying different weights on each independent management module comprising changing the different weights on each independent management module on each sub-time period.

In some embodiments, the one or more optimization algorithms comprises clustering optimization, classification, artificial neural networks, deep neural network, reinforcement machine learning, or deep reinforcement learning in combination with minimization of a weighted cost function.

In some embodiments, the recommendation optimization data comprises a plurality of options, each option being indicative of a different optimization of the plurality of the optimization parameters.

In some embodiments, the processing unit is configured and operable to control the plurality of independent management modules in real-time to selectively operate an adequate management module performing the optimal warehouse task at the optimal time.

According to another broad aspect of the present disclosure, there is provided a method for optimizing warehouse management, the method comprising controlling, by at least one computerized system, a plurality of independent management modules being configured and operable to manage different warehouse tasks; generate for a selected period of time a recommendation optimization data comprising a plurality of optimization parameters; providing prioritization between the independent management modules; and providing an optimal operation of each management module in order to enable at least one of: the maximal number of orders to be prepared per the selected time period, attributing optimal resources to complete at least one optimization task or performing in the selected time period at least one maintenance task.

In some embodiments, the method further comprises receiving the recommendation optimization data generated by each independent management module and generating a global optimization data being indicative of the recommendation optimization data of all the independent management module to selectively operate one or more of the independent management modules, to optimize the timing of the different warehouse tasks, and to provide an optimal recommendation optimization data for each independent management module taking into consideration the recommendation optimization data provided by the other management modules. Generating a global optimization data may include applying one or more optimization algorithms on the plurality of the optimization parameters. The one or more optimization algorithms may include performing a plurality of simulations on the plurality of the optimization parameters.

In some embodiments, the method further comprises dividing the selected time period into a plurality of sub-time periods, wherein applying different weights on each independent management module comprises changing the different weights on each independent management module on each sub-time period.

According to yet another broad aspect of the present disclosure, there is provided at least one non-transitory computer-readable medium that stores instructions that once executed by a computerized system cause the computerized system to execute a process for optimizing a warehouse management, the non-transitory computer-readable medium stores instructions for controlling, by at least one computerized system, a plurality of independent management modules being configured and operable to manage different warehouse tasks, generating a recommendation optimization data for a selected period of time comprising a plurality of optimization parameters; providing prioritization between the independent management modules; and providing an optimal operation of each management module in order to enable at least one of: the maximal number of orders to be prepared per the selected time period, attributing optimal resources to complete at least one optimization task or performing in the selected time period at least one maintenance task or maximum storage density in the warehouse by at least one of consolidation of boxes or emptying boxes.

According to yet another broad aspect of the present disclosure, there is provided an automated warehouse that comprises: a storage configured to store multiple items, wherein the multiple items are stored in item containers; a plurality of picking stations that comprise at least one picking station; one or more robots that are configured to convey item containers to the plurality of picking stations; and an optimization system as defined above.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a general functional block diagram showing an optimization system according to some teachings of the presently disclosed subject matter;

FIG. 2 is a simplified schematic illustration of the architecture of an optimization system according to some teachings of the presently disclosed subject matter;

FIG. 3 is a more detailed functional block diagram showing an example of an optimization system according to some teachings of the presently disclosed subject matter;

FIG. 4 is a functional flow chart showing an optimization method according to some teachings of the presently disclosed subject matter;

FIG. 5 is a schematical illustration of an automated warehouse according to some teachings of the presently disclosed subject matter;

FIG. 6 is a functional block diagram showing the task manager system according to some teachings of the presently disclosed subject matter; and

FIG. 7 is a functional flow chart showing the optimization method according to some teachings of the presently disclosed subject matter.

### DETAILED DESCRIPTION OF EMBODIMENTS

Any reference in the specification to a method should be applied mutatis mutandis to a device or system capable of executing the method and/or to a non-transitory computer-readable medium that stores instructions for executing the method.

Any reference in the specification to a system or device should be applied mutatis mutandis to a method that may be executed by the system, and/or may be applied mutatis mutandis to a non-transitory computer-readable medium that stores instructions executable by the system.

Any reference in the specification to a non-transitory computer-readable medium should be applied mutatis mutandis to a device or system capable of executing instructions stored in the non-transitory computer-readable medium and/or may be applied mutatis mutandis to a method for executing the instructions.

Any combination of any module or unit listed in any of the figures, any part of the specification, and/or any claims may be provided.

The specification and/or drawings may refer to a processor. The processor may be a processing circuitry. The processing circuitry may be implemented as a central processing unit (CPU) and/or a graphics processing unit (GPU), and/or one or more other integrated circuits such as application-specific integrated circuits (ASICs), field programmable gate arrays (FPGAs), full-custom integrated circuits, or a combination of such integrated circuits. A computerized system may include one or more processors and may also include additional units or components such as memory units, communication units, and the like.

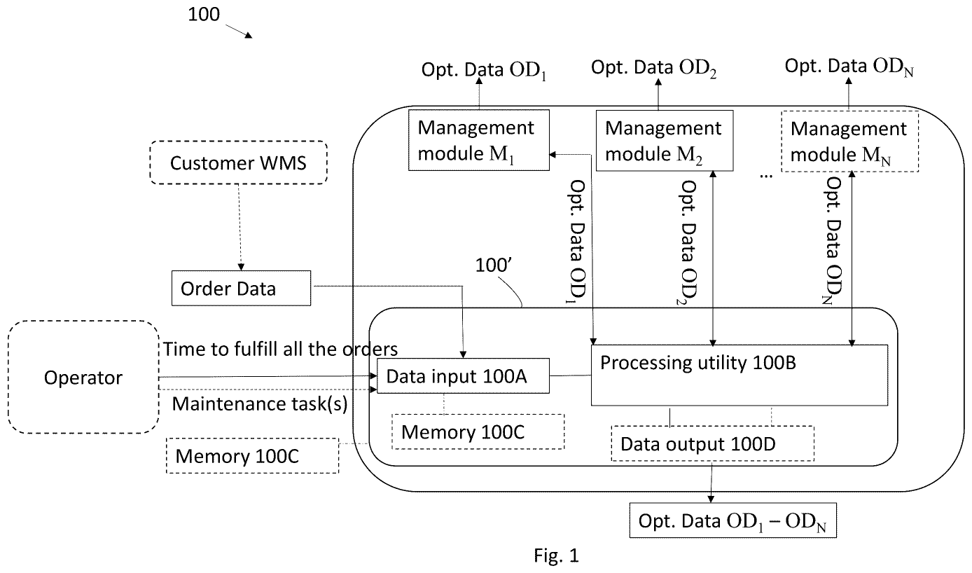

Reference is made to FIG. 1, showing a general functional block diagram of an optimization system 100 for use in automatic warehouses, of the presently disclosed subject matter which may be a part of or in data communication with the WMS. The optimization system 100 includes a control unit 100′ configured as a computer system comprising a processing utility 100B and being a part of and connected to a computer network and N (N≥2) independent management modules M₁, M₂, . . . , MN coupled to/in data communication with the processing utility 100B. Each management module is configured to manage corresponding (different) warehouse tasks as will be described further below.

The optimization system 100 may comprise a general-purpose computer processor, which is programmed in software to carry out the functions described herein below. Unless specifically stated otherwise, as apparent from the following discussions, it is appreciated that throughout the specification discussions utilizing terms such as “determining”, “processing” or the like, refer to the action and/or processes of a computer that manipulates and/or transforms data into other data. Also, operations in accordance with the teachings herein may be performed by a computer specially constructed for the desired purposes, or by a general-purpose computer specially configured for the desired purpose by a computer program stored in a computer-readable storage medium.

The optimization system 100 includes at least one computer entity linked to a server via a network, wherein the network is configured to receive and respond to requests sent across the network, and also transmits one or more modules of computer-executable program instructions and displayable data to the network connected user computer platform in response to a request, wherein the modules include modules configured to: receive and transmit order and time data, transmitting a recommendation optimization data based on the optimization, for display by the network connected user computer platform. The presently disclosed subject matter may include computer program instructions stored in the local storage that, when executed by optimization system 100, cause optimization system 100 to receive order data and time data and determine the recommendation optimization data. The computer program product may be stored on a tangible computer-readable medium, comprising: a library of software modules which cause a computer executing them to prompt for information pertinent to a recommendation optimization data, and to store the information or to display recommendation optimization data.

In some embodiments, the optimization system 100 is configured in a cloud-based configuration and/or utilizes Internet-based computing so that parts of processing utility 100B, and/or memory may reside in multiple distinct geographic locations.

The control unit 100′ also includes a data input utility 100A including a communication module for receiving order data being indicative of orders to be prepared using items from the warehouse and time data being indicative of a predetermined period of time at which the preparation of the orders should be completed. The time data is generally directly defined by the operator via an interface being in communication with data input utility 100A, representing the optimal time at which all the orders should be fulfilled or the time at which the operator needs to close the working day. The time data may include a predetermined period of time which may be for example from a few hours to a week, and/or a specific time at which all the tasks should be completed (for example at 4:00 PM). As illustrated in the figure, the order data may be received, for example, from a customer management system (customer WMS) being in data communication of the processor/data input utility 100A.

The order data comprises at least one order line or recall data. Each order line typically includes an item identifier (e.g. SKU), a due date data for supplying the item, and a quantity. The order data may also comprise an approximate distribution of orders throughout a certain period, defining “regular” and “peak” days. Usually, the operator is already aware of the number of orders (at least approximately) that should be fulfilled one day before. An indication for prioritized handling may also be added to the order line. The recall data may comprise an item identifier such as SKU and/or specific box and/or specific batch and a quantity. The batch refers to a production number enabling the manufacturer to identify the batch of production of items. The production number enables to recall, for example, for any reason (e.g. detection of bacteria), some items of certain production batches.

The control unit 100′ can include or be associated with an optional memory (i.e., non-volatile computer-readable medium) 100C for storing the input/output data, a database, or the computer program as will be detailed below. The database may be a cloud-based system. In an example, the cloud-based system may be a distributed blockchain system, wherein a number of parties (e.g. manufacturer, recycler, retailer) have access to the distributed ledger. It should thus be understood that the term “control system” should be interpreted broadly, covering local controllers (data analyzers) in data communication with the sensing unit/system, as well as cloud computing-based systems. The latter is a type of Internet-based computing that provides shared computer processing resources and data (such as servers, storage, and applications) to computers and other devices through the computer network (or communication network), such as the Internet. Cloud computing and storage solutions provide users and enterprises with various capabilities to store and process their data in either privately owned or third-party data centers that may be located far from the user-ranging in distance from across a city to across the world. Thus, the present disclosure provides for using the cloud computing technique, according to which a central data analyzer (software) is used to receive the sensing data from multiple products' storage locations and using these multiple data sources for optimizing the above-mentioned identification of the product types and product status monitoring (e.g. utilizing self-learning modes, models' optimization, etc.). Memory 100C may be integrated within control unit 100′ or the optimization system 100 or may be an external storage device accessible by optimization system 100. The software may be downloaded to task manager system 100 in electronic form, over a network, for example, or it may alternatively be provided on tangible media, such as optical, magnetic, or electronic memory media. The computer program described above may be intended to be stored in memory 100C, or in a removable memory medium adapted to cooperate with a reader of the task manager system 100, comprising instructions for implementing the method as will be described below. More specifically, the computer program may be in communication with an interface to receive order and time data.

The processing utility 100B is adapted to control the N independent management modules, providing prioritization between the independent management modules and an optimal operation of each management module in order to enable at least one of: the maximal number of orders to be prepared per the selected time period, performing in the selected time period at least one maintenance task. The maintenance task(s) may include at least one of managing and replenishment an inventory, filling a stock, selecting an optimal location of selected items before or after pick-up, consolidation or emptying boxes to enable maximum storage density in the warehouse, cycle count, space reduction, performing warehouse maintenance, recalling, and/or replacement of batteries. A certain prioritization may be established between the different maintenance tasks and the pick-up task to be able to fulfill the operator's requirements.

Each independent management module M₁, M₂, . . . , M_{N} is configured and operable to manage different warehouse tasks. Such warehouse tasks include at least one of items location (i.e. displacing the items from the storage units to the picking station or from the replenishment station at which the item containers are unloaded from the truck either on pallets or not to the storage units) or one or more optimization tasks. The optimization tasks may include at least one of maintenance task, order management, inventory management, mission planning, robot navigation, and task management as will be described in more details further below. Each independent management module M₁, M₂, . . . , M_{N} is configured and operable to generate a corresponding recommendation optimization data OD₁, OD₂, . . . , OD_{N} for a selected period of time comprising a plurality of optimization parameters. Accordingly, each module includes a respective processing unit (not shown) which determines the recommendation optimization data for each module.

The recommendation optimization data OD₁, OD₂, . . . , OD_{N} is being relayed from the corresponding independent management module M₁, M₂, . . . , M_{N} to the processing utility 100B for processing. The processing utility 100B is configured and operable to receive the recommendation optimization data OD₁, OD₂, . . . , OD_{N} generated by the independent management module M₁, M₂, . . . , M_{N}, respectively, to selectively operate one or more of the independent management modules M₁, M₂, . . . , M_{N}, to optimize the timing of the different warehouse tasks and to provide an optimal recommendation optimization data of each independent management module taking into consideration the recommendation optimization data provided by the other management modules.

In some embodiments, the processing utility 100B processes the recommendation optimization data OD₁, OD₂, . . . , OD_{N}, and the recommendation optimization data is updated/corrected in accordance with an optimal recommendation optimization data of each independent management module, i.e., by considering the recommendation optimization data of the other management modules. The updated recommendation optimization data is then relayed/communicated to the independent modules. Each independent module then relays the recommendation optimization data to the robots and/or the picking stations in the warehouse depending on the warehouse tasks to be carried out. In other embodiments, the processing utility 100B relays/provides the recommendation optimization data OD₁, OD₂, . . . , OD_{N} (after being updated) via an optional output utility 100D.

In some embodiments, the selective operation of the independent management module M₁, M₂, . . . , M_{N} is performed by prioritization between the different warehouse tasks, i.e., some tasks may be of higher priority than others at the selected period of time. To this end, the utility 100B is configured and operable to apply one or more optimization algorithms/protocols on the plurality of the optimization parameters to selectively operate the independent management modules.

In some embodiments, such optimization algorithms/protocols include performing a plurality of simulations on the plurality of the optimization parameters to selectively operate the independent management modules. These simulations are associated with applying/assigning various weights to each independent module. The different independent modules are assigned with different weights in accordance with the prioritization of the different warehouse tasks at the selected period of time such that one or more independent modules associated with high-priority asks are assigned with higher weights.

In some embodiments, the one or more optimization algorithms/protocols on the plurality of the optimization parameters includes, inter alia, clustering optimization, classification, artificial intelligence (AI) techniques such as reinforcement learning and/or deep reinforcement learning in combination with minimization/reduction of a cost function (e.g. weighted).

For example, the robot navigation management module, as well as the inventory management module, can be optimized independently but if both management modules are optimized concurrently (e.g. at the same time), the optimization will provide a much better outcome than each one separately. Moreover if at a specific period of time, the robot navigation management module is the most important task to optimize, later on, the inventory management module may be the more adequate task to optimize, keeping all the other tasks to be optimized as well but with a different weight. The timing of the prioritization of the different management modules may be determined by using prediction models.

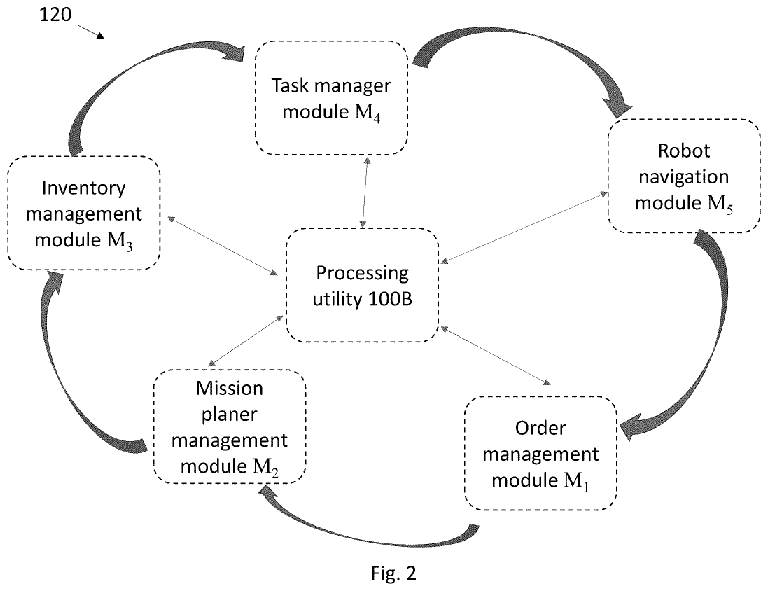

Reference is made to FIG. 2, showing a simplified schematic illustration of the architecture of an optimization system 120 for use in automatic warehouses, of the presently disclosed subject matter. The optimization system 120 includes the processing utility 100B connected to five different functional-independent modules M1-M5 adapted for optimizing various warehouse management processes/functions. In particular, order management M1 is responsible for optimizing the arrangement of item containers in the various picking stations (e.g., grouping the orders by the similarity of items), mission planer management module M2 is responsible for prioritizing various missions in the warehouse (e.g., orders and maintenance tasks), inventory management module M3 is responsible for optimizing the location of item containers in the warehouse, the task management module M4 is responsible for optimization of utilization of resources (e.g., workers and robots) in the warehouse and the robot navigation module M5 is responsible for calculating the optimal pathways/routes in the warehouse for the robots to complete their tasks.

The processing utility 100B uses recommendation optimization data from the different modules to prioritize between the modules as well as optimize the operation of each module as a stand-alone module to enable the accomplishment of a maximal number of orders to be prepared in a selected time period and possibly performing in the one or more maintenance task within this time frame. Prioritization can be carried out by various optimization techniques as described above, e.g., by performing simulations and assigning weights to the different modules as described in detail further below. This way, the optimization system provides another optimization level/stage in addition to optimizations provided by each of the different modules independently.

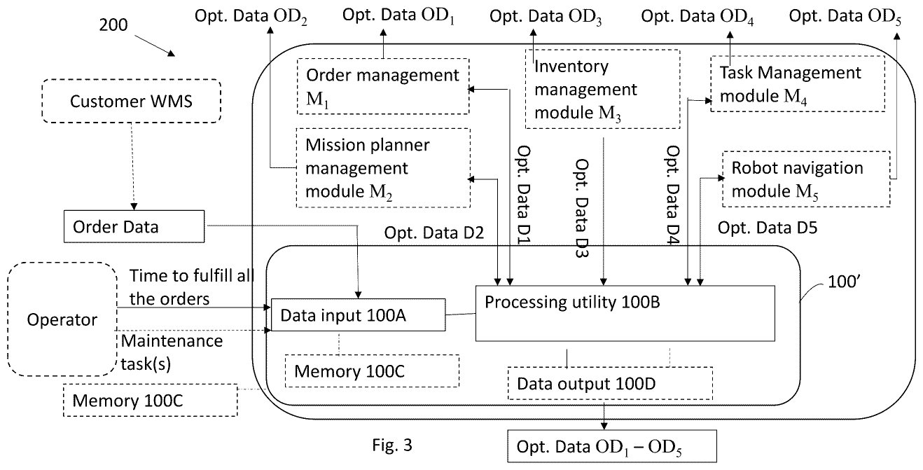

Reference is made to FIG. 3, showing a functional block diagram of an optimization system 200 for use in automatic warehouses according to some embodiments of the presently disclosed subject matter. To facilitate understanding, the same reference numbers are used to identify similar components in all the examples described herein.

As shown in the figure, the optimization system 200 includes comprises at least two of the following modules: an order management module M₁, a mission planner management module M₂, an inventory management module M₃, task management module M₄, and a robot navigation module M₅.

The order management module M₁ is configured and operable to receive order data being indicative of a plurality of orders to be prepared and to generate recommendation optimization data being indicative of prioritization between item containers to be moved to one or more picking stations in accordance with a due time data. The due time data can include at least one of such optimization parameters as:
an expected delivery due date. For example, 1000 orders are to be treated/prepared before a cut-off time of e.g., 15:00.
an indication for prioritized handling. For example, prioritized handling of orders relating to two customers, but one is in higher priority concerning the other.
boost, i.e., a specific demand from the operator or the WMS. For example, a certain order is suddenly being prioritized as highly important for fulfillment.
commonality/similarity of one or more items. For example, the same item is ordered by different customers so a required number of this item will be mobilized to the same picking station.

A non-limiting example of the order management module is described in WO 22/038579 assigned to the assignee of the present disclosure. The order management module M₁ may also be responsible for the grouping and timing of orders in each picking station.

The mission planner management module M₂ is configured and operable to receive task data being indicative of a plurality of tasks to be performed by one or more robots, processing the task data, and generating recommendation optimization data being indicative of prioritization between the plurality of tasks to be performed. The recommendation optimization data may include at least one of such optimization parameters as:
picking station selectivity, namely, provision of different item containers to the relevant opened picking station(s).
Location selectivity, for example, displacing cold items to a designated/allocated storage (i.e. cold) in the warehouse as fast as possible.
maintenance tasks.

A non-limiting example of the order management module is described in WO 22/038579 assigned to the assignee of the present disclosure.

The inventory management module M₃ is configured and operable for receiving at least one item container data (e.g., a container from the replenishment stage or returned items) and a warehouse map data being indicative of the locations of each item container in a storage. The inventory management module M₃ is further configured for processing the at least one item container data and the warehouse map data for generating a recommendation optimization data including an optimal location data being indicative of a specific optimal location at which the at least one item container is to be positioned on the storage. A non-limiting example of the order management module is described in WO 15/189849 assigned to the assignee of the present disclosure.

The optimal location data can be determined in accordance with one or more location optimization parameters including at least one of the location history data of items, weather, and accordingly temperature at different locations in the warehouse, or discounts on items. For example, some items (e.g., food) should only be stored in a certain temperature range. Accordingly, the recommendation optimization data (optimal location data) of the inventory management module M₃ will be a location within the warehouse where such temperature range is maintained. The optimal location data include data that can be indicative of proximity to a picking station or a height from the ground. This can enable increased accessibility for a robot to pick up the item container and mobilize it to one of the picking stations.

The map data is informative of locations of all the stock (i.e., existing item containers) in the warehouse at a given point in time at which the least one item container is to be placed/positioned and possible temperature pattern profile in the warehouse. The map data can be stored in the memory 100C and can be updated each time an item container is introduced to the warehouse, or an existing item container is moved from one location to another. A non-limiting example of the order management module is described in WO 22/038579 assigned to the assignee of the present disclosure.

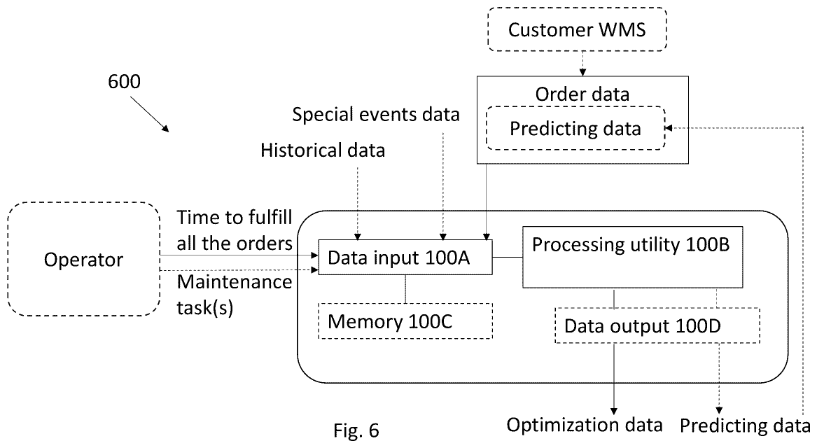

The task management module M₄ is configured and operable for receiving (i) at least one maintenance task to be performed in the warehouse, wherein the at least one maintenance task comprises at least one of replenishment, consolidation, cycle count, space reduction, warehouse maintenance, recall or replacement of batteries; (ii) time data being indicative of a predetermined period of time at which the preparation of orders to be prepared using items from the warehouse should be completed and (iii) warehouse resources to be attributed in the predetermined period of time including at least one of a predefined number of picking stations being associated with a certain number of picker persons and a predefined number of robots; processing the time data by performing a plurality of simulations on a plurality of optimization parameters, for the given time data, and generating a simulation data including a plurality of sets of optimization parameters, wherein the sets of optimization parameters includes the warehouse resources and allocation of at least one maintenance task;
determining a selected set of optimization parameters based on the simulation data including the allocation of at least one maintenance task to be completed together with the preparation of the orders and an optimized attribution of the resources of the warehouse, to thereby generate a recommendation optimization data for the predetermined period of time comprising a plurality of optimization parameters being indicative of optimal resources that should be optimally attributed to complete at least one optimization task. The task management module M₄ and principles of operation thereof will be described more in detail herein below with reference to FIG. 6.

Task manager module M₄ may include a data input utility including a communication module for receiving order data being indicative of orders to be prepared using items from the warehouse and time data being indicative of a predetermined period of time at which the preparation of the orders should be completed, an optional memory (i.e. non-volatile computer-readable medium) for storing the input/output data, a database or the computer program, and a processing utility adapted to processing the order and time data, and generating a recommendation optimization data comprising a plurality of optimization parameters being indicative of optimal (e.g. minimum) resources that should be optimally attributed to complete at least one task including at least one of completion of the preparation of the orders and at least one maintenance task and an optional data output utility being configured and operable to provide the recommendation optimization data. The time data is generally directly defined by the operator via an interface being in communication with the data input utility, representing the optimal time at which all the orders should be fulfilled or the time at which the operator needs to close the working day.

The plurality of optimization parameters may comprise a predicted optimized number of robots of each type that should be actuated and/or predicted an optimized number of picker persons and/or predicted an optimized number of picking stations and/or allocation of at least one maintenance task to at least one picker person when not be dedicated at the station.

The robot navigation management module M₅ is configured and operable for receiving request data being indicative of location change of at least one robot and generating recommendation optimization data indicative of an optimal path for at least one robot. The optimal path includes at least one optimization parameter of the fastest path, shortest path, and most energy efficient path, velocity. A non-limiting example of the order management module is described in WO 20/250101 assigned to the assignee of the present disclosure.

As mentioned above, the processing utility 100B is adapted to control the independent management modules M₁-M₅ to provide prioritization between the independent management modules and an optimal operation of each management module in order to enable at least one of: the maximal number of orders to be prepared per the selected time period, performing in the selected time period at least one maintenance task. For example, the selected time period may be provided for any predetermined period of time defined by the operator: a certain hour range, daily, weekly or monthly.

The prioritization between the independent management can be carried out/implemented by applying one or more optimization algorithms/techniques on the plurality of the optimization parameters associated with recommendation optimization data from all the independent management modules. In some embodiments, the prioritization is implemented by performing a plurality of simulations on the plurality of the optimization parameters associated with recommendation optimization data from all the independent management modules.

In some embodiments, the prioritization is implemented by machine learning models such, inter alia, as artificial neural networks, deep neural network, reinforcement machine learning, and/or deep reinforcement learning in combination with minimization of a weighted cost function. The machine learning models may be trained by the plurality of simulations (i.e., training set).

The activation of the mission planner management module may include an “on-the-go” mission referring to a task that can be accomplished by a given robot while performing another mission. For instance, when an available robot (an “empty” robot that does not carry anything) is located at a certain location in the warehouse and needs to perform self-maintenance, e.g., battery changing or recharging at a location near the picking stations can take a certain item container and bring it closer to the picking stations and/or take an item container and move it to a lower height. Also, an available robot may be positioned a certain near the picking station (e.g., after bringing a certain to one of the picking stations) and is directed to pick another container at the other end of the warehouse, on the way it can take a container for stock optimization. Accordingly, the mission planner management module M₂ and the inventory management module M₃ are prioritized and are assigned with maximal weights.

In some cases, e.g., in rush hours a prioritization algorithm can determine or predict that certain pathways/roads in the warehouse may be used by a large number of robots which may cause traffic congestion or “bottlenecks.” Accordingly, mission planner management module M₂ and the robot navigation management module M₅ are prioritized to find alternative pathways or close other pathways to at least one of the robots or to decrease the velocity of at least one of the robots to avoid traffic congestion or “bottlenecks” or queues near the picking stations.

In some cases, a certain robot can be assigned with a low-priority mission since another robot can perform top-priority missions more effectively, e.g., when this robot can perform the top priority mission more quickly or since this robot is located at a location that will avoid traffic congestion or “bottle-necks” on his path to complete the top priority mission. Accordingly, the mission planner management module M₂ and the robot navigation management module M₅. If the high-priority mission is associated with a replenishment task, the inventory management module M₃ is prioritized as well while order management module M₁ may be prioritized when the high-priority mission is to mobilize a container to one of the picking stations.

In some cases, a prioritization algorithm can determine that activating an optimal number (e.g., relatively small number) of robots to avoid traffic congestion or “bottlenecks” in order to accomplish some maintenance task (e.g., replenishment or consolidation) more efficiently. Accordingly, the task management module is M₄, and inventory management module M₃ is prioritized.

The prioritization algorithms can be carried out in accordance with certain demands/conditions from the operator. For example, such demand/condition can be that a maximal number of orders are to prepare with a given number of workers (e.g., when some workers are sick or one or more workers are on vacation) or with a given number of robots or picking stations (e.g., when one or more robots or picking stations are out of service for some reason). The demand may be a maintenance task to be performed periodically, e.g., a cycle count or consolidation procedure that should take place once a week or once a day. The simulations can include applying different weights on each independent management module. These weights provide the establishment of certain prioritization of the different tasks associated with the different independent modules. For example, a certain task is of high priority at the selected period of time so the corresponding one or more modules will be assigned with weights of high value. The simulations may be performed before the selected period of time or before special events such as Black Friday, or season changing (recall of the spring/summer items at the end of summer or recall of fall/winter items after the winter and restock with the new season). These prioritization algorithms may also use historical data related to the special events from previous years. The historical data may comprise the time of the special event(s), their expected duration, the item(s) related to these special events, or their expected quantities. The prioritization algorithm (e.g., simulations) may also be performed in real-time or nearly in real-time to selectively operate an adequate management module performing the optimal warehouse task at the optimal time. For example, in case unexpected events may occur, such as a large number of orders may suddenly need to be prepared or a large shipment of items that suddenly arrived at the warehouse and needs replenishment.

In some embodiments, the processing utility 100B is configured and operable to divide the selected time period into a plurality of sub-time periods. In each sub-time period, different weights are applied on each independent management module comprising changing the different weights on each independent management module in each sub-time period. For example, when the selected time period is a given day, orders are usually prepared and shipped in the morning hours (e.g., 08:00-12:00) while maintenance tasks are accomplished in the afternoon or in later hours (e.g., 14:00-17:00). The selected time period is a day which may include special event(s) related to a significant increase of ordering of specific items in a specific period of time or a general increase of ordering such as black Friday typically multiplies by 4 to 5 the numbers of items to be shipped compared to a normal routine day. The system may then prioritize maintenance tasks on other days during this week before the special event since on the day of the special event prioritization will probably be on the preparation and shipping of the orders.

In some embodiments, the recommendation optimization data comprises a plurality of options, each option being indicative of a different optimization of the plurality of the optimization parameters. The recommendation optimization data may provide one or more optimization parameters according to the operator's needs/requirements. More specifically, the operator may decide which optimization parameter(s) he is interested in, and a plurality of options may be provided to him, each option being indicative of a different set of optimization parameters. For example, if it is needed to accomplish 100 orders on a certain day and the given resources are 10 robots and 10 workers, and the operator would like to perform cycle count and replenishment tasks, the optimization system can provide one or more options how to optimally complete these tasks. For example, the optimization system can suggest a first option recommending to proceed with the orders in the morning hours by activating the mission planner management module and accomplishing replenishment and cycle count in the afternoon hours of the same day or a second option in which the orders are proceeded all the day without accomplishing maintenance tasks such a maximum weight is attributed to order management and robot navigation management and the replenishment and cycle count are accomplished in the next day which may include few orders together with the activation of the inventory management module for optimizing the optimal location of the boxes in the storage.

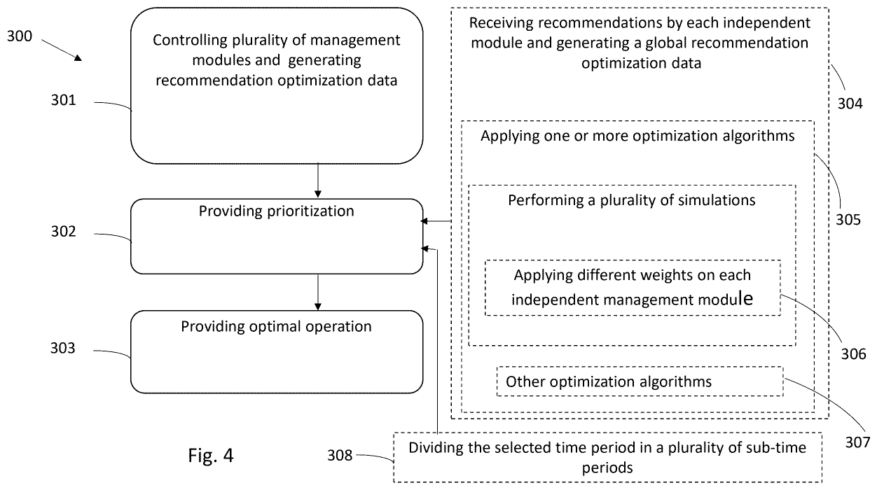

Reference is made to FIG. 4, showing a functional flow chart of a method for optimizing a warehouse management 300 of the presently disclosed subject matter. Method 300 includes controlling in 301, by at least one computerized system, a plurality of independent management modules being configured and operable to manage different warehouse tasks and generate a recommendation optimization data for a selected period of time comprising a plurality of optimization parameters. For example, such management modules can include at least two of a mission planner management module, an order management module, an inventory management module, a robot navigation management module, and a task management module. Providing in 302 prioritization between the independent management modules and providing in 303 an optimal operation of each management module in order to enable at least one of: the maximal number of orders to be prepared per the selected time period, attributing optimal resources (e.g., workers, picking stations or robots) to complete at least one optimization task or performing in the selected time period at least one maintenance task.

In some embodiments, prior to the prioritization of the independent modules in 302, method 300 may include receiving in 304 the recommendation optimization data generated by each independent management module and generating a global recommendation optimization data to selectively operate one or more of the independent management modules, to optimize the timing the different warehouse tasks and to provide an optimal recommendation optimization data of each independent management module taking into consideration the recommendation optimization data provided by the other management modules.

In some embodiments, generating recommendation optimization data in 304 may include applying in 305 one or more optimization algorithms on the plurality of the optimization parameters. In some embodiments, the one or more optimization algorithms in 305 include performing in 306 a plurality of simulations on the plurality of the optimization parameters for the given time data, generating a simulation data including a plurality of sets of optimization parameters and determining a selected set of optimization parameters based on the simulation data including the allocation of at least one maintenance task to be completed together with the preparation of the orders and an optimized attribution of the resources of the warehouse. The sets of optimization parameters include the warehouse resources and allocation of at least one maintenance task. In some embodiments, performing a plurality of simulations on the plurality of the optimization parameters comprises applying, in 306, different weights on each independent management module. Alternatively, or additionally, the one or more optimization algorithms in 305 may include in 307 clustering optimization, classification, artificial neural networks, deep neural network, reinforcement machine learning, or deep reinforcement learning in combination with minimization of a weighted cost function.

In some embodiments, before the prioritization of the independent modules in 302, method 300 may also include dividing in 308 the selected time period into a plurality of sub-time periods, wherein applying different weights on each independent management module comprising changing the different weights on each independent management module on each sub-time period.

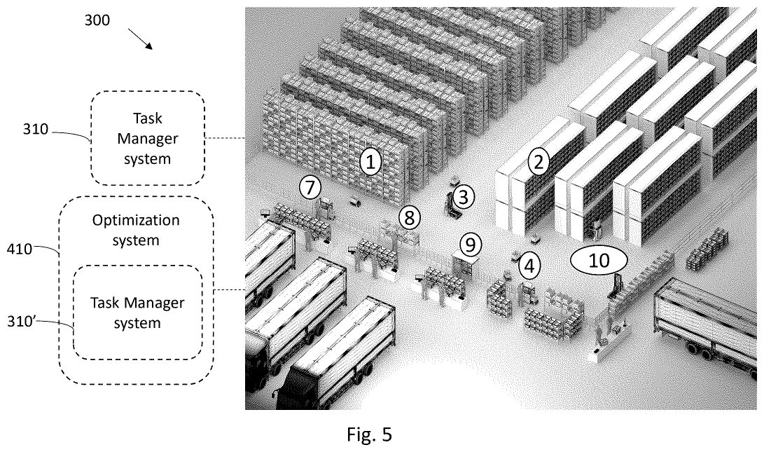

Reference is made to FIG. 5, showing a schematic diagram of an automated warehouse 400 of the presently disclosed subject matter. Automated warehouse 400 comprises storage 1 and 2 configured to store multiple items, wherein the multiple items are stored in item containers; a plurality of picking stations 7,8,9 that comprise at least one picking station; replenishment/recall station 10, one or more robots 3 and 4 that are configured to convey item containers to the plurality of picking stations; and an optimization system 410 as defined above and/or a task manager system 310 as will be defined further below. In particular, in some embodiments, the automated warehouse 400 can comprise the task manager system 310 as stand-alone system. In other embodiments, the task manager system 310′ can operate as part (module) of the optimization system 410.

An automated warehouse may be managed by an automated warehouse control system (WCS) being configured and operable to perform automated warehouse control and management operations. As defined above, optimization system 410 and/or task manager system 310 may be a part of a Warehouse Control System (WCS) configured to perform automated warehouse control and management operations. Although storage 1 and 2 represent storage under different conditions, the presently disclosed subject matter is not limited to any type of storage, which may be of the same or different type. Similarly, although different picking stations 7-9 are shown in the figure, the presently disclosed subject matter is not limited to any type and any number of picking stations, which may be of the same or different type. Also in this case, although robots 3 and 4 are shown in the figure, the presently disclosed subject matter is not limited to any type and any number of robots, which may be of the same or different type. For example, two types of robots may be provided. One type of robot (e.g. robotic carts) may be configured for accessing the boxes of one or more lower shelves and providing the boxes with the picking stations and another type of robot (e.g. robotic lift units) may be configured for accessing the boxes of the higher shelves and providing the boxes to the picking stations. The robots may differ by size, complexity, cost, height, span of movement, and the like.

In some embodiments, the WCS is in data communication with each robot to determine and control the parameters of its displacement (path and speed). The WCS may update in real-time or near real-time the position of each robot in the warehouse and provides the robot with routes. The WCS may request a robot to retrieve a box from its current location and deliver it to a certain picking station. The WCS may instruct a robot to move a box from one picking station to another.

Reference is made to FIG. 6, showing a functional block diagram of a task manager system 600 of the presently disclosed subject matter which may be a part of the WCS. Task manager system 600 comprises a computer system comprising a processing utility 100B and being a part of and connected to a computer network. Task manager system 600 may comprise a general-purpose computer processor, which is programmed in software to carry out the functions described herein below. Unless specifically stated otherwise, as apparent from the following discussions, it is appreciated that throughout the specification discussions utilizing terms such as “determining”, “processing” or the like, refer to the action and/or processes of a computer that manipulate and/or transform data into other data. Also, operations in accordance with the teachings herein may be performed by a computer specially constructed for the desired purposes, or by a general-purpose computer specially configured for the desired purpose by a computer program stored in a computer readable storage medium. Task manager system 600 includes a data input utility 100A including a communication module for receiving order data being indicative of orders to be prepared using items from the warehouse and a time data being indicative of a predetermined period of time at which the preparation of the orders should be completed, an optional memory (i.e. non-volatile computer readable medium) 100C for storing the input/output data, a database or the computer program as will be detailed below, and a processing utility 100B adapted to processing the order and time data, and generating a recommendation optimization data comprising a plurality of optimization parameters being indicative of optimal (e.g. minimum) resources that should be optimally attributed to complete at least one task including at least one of completion of the preparation of the orders and at least one maintenance task and an optional data output utility 100D being configured and operable to provide the recommendation optimization data. The processing utility 100B may be connected to a database being capable of at least one maintenance task to be performed in the warehouse. The database may be integrated in memory 100C or not. The database may store at least one maintenance task (as a function of certain period of time or not) as well as their respective parameters. Additionally or alternatively, the operator may input via data input utility 100A at least one maintenance task to be performed in the warehouse according to the warehouse's specific needs. Additionally or alternatively, the operator can access the database and select at least one maintenance task from the database to be performed in the warehouse for a predetermined period of time or not. Additionally or alternatively, the database may automatically input to the task manager system at least one maintenance task to be performed automatically e.g. for a predetermined period of time. Any set of maintenance tasks may be selected at any specific time. In some embodiments, the system provides the flexibility of adapting the execution of the maintenance task(s), if any, at any given time, according to the orders to be executed at the same given time. If the rate of the completion of the orders does not progress as expected, the operator may decide to remove the execution of any maintenance task for a certain time period. Alternatively, if the rate of the completion of the orders is higher than expected, the operator may decide to add some other maintenance task(s) to be executed during a certain time period e.g. until the end of same day. The different maintenance tasks can also be prioritized by the operator or by the system. The maintenance tasks may be executed sequentially once one of the other maintenance tasks has been completed. Alternatively, the execution of the maintenance task may be performed in parallel. The execution of the maintenance task(s) may be performed concurrently with the orders fulfillment or in between it. The time data is generally directly defined by the operator via an interface being in communication with data input utility 100A, representing the optimal time at which all the orders should be fulfilled or the time at which the operator needs to close the working day. The time data may include a predetermined period of time which may be for example from a few hours to a week, and/or a specific time at which all the tasks should be completed (for example at 4:00 PM). As illustrated in the figure, the order data may be received, for example, from a customer management system being in data communication of the processor/data input utility 100A. The order data may be as defined above with respect to FIG. 1. The plurality of optimization parameters may comprise predicted optimized number of robots of each type that should be actuated and/or predicted optimized number of picker persons and/or predicted optimized number of picking stations and/or allocation of at least one maintenance task to at least one picker person when not be dedicated at the station. Therefore, the recommendation optimization data may comprise optimization data generated in real-time (i.e. during the preparation of the orders), if it seems that the different tasks would not be completed on time or if the time of some pickers seems to be wasted. Alternatively, the recommendation optimization data may be generated before the preparation of the orders including the day at which the orders are prepared or at least one day before the preparation of the orders, to anticipate and save the number resources (and optionally their availability) required for accomplishing the different tasks. When the recommendation optimization data is generated before the preparation of the orders, the recommendation optimization data comprises data being indicative of at least one of the followings: optimal location of selected items before or after pick-up to, optimal time of operation of picking stations before and/or during the preparation of the orders, managing time of picker persons. For example, if it is expected that some specific items would be popular in the next orders, the item containers holding these specific items may be displaced within the warehouse to be placed on storage casing(s) being closer to the picking stations to enable a shorted path to be run through for the robots. Moreover, the task system manager is also capable of readjusting the recommendation optimization data in real-time when the recommendation optimization data is generated before the preparation of the orders. The recommendation optimization data may provide one or more optimization parameters according to the operator's needs. More specifically, the operator may decide which optimization parameter(s) he is interested in, and a plurality of options may be provided to him, each option being indicative of a different set of optimization parameters being indicative of different optimization of the plurality of the optimization parameters. This may be implemented by performing a plurality of simulations (e.g. on-demand) on the plurality of the optimization parameters, to determine the optimal set of optimization parameters. For example, the recommendation optimization data may be provided for any predetermined period of time defined by the operator: daily, weekly or monthly. The recommendation optimization data may provide the number of picker persons required for completing the orders only, for alternating between completion of orders and maintenance tasks. More specifically, the operator may decide whether he desires to include maintenance task(s) in the optimization parameters or not. The maintenance task(s) may comprise replenishment and/or consolidation and/or cycle count and/or space reduction and/or warehouse maintenance and/or recall and/or replacement of batteries. A certain prioritization may be established between the different maintenance tasks and the pick-up task to be able to fulfill the operator's requirements. The replenishment task refers to a task during which a predefined number of new item containers are introduced into the WCS. The replenishment task requires picker person(s) and robot(s) resources. The new item containers are scanned at their specific location (i.e. specific storage casing in the warehouse and specific storage shelf on the storage casing). The replenishment data is entered in the WCS. The consolidation task refers to a task during which the item containers being partially filled are identified, and some items are displaced from one item container to another to completely fill the item containers and to thereby minimize the number of item containers in the system. The consolidation task requires picker person(s) to move the items from and to boxes and robot(s) resources to displace the boxes. The cycle count refers to a task during which the number and optionally the type (being defined by the item identifier) of items in each item container is/are identified and correlated with the item data in the WCS, to verify that there are no discrepancies in the WCS. The cycle count requires picker person(s) and robot(s) resources. For example, if a box has been brought to the picking station for picking purposes, and after the picking, the number of items is under a certain threshold, the system can recommend to the picker person to perform a cycle count. Alternatively, the cycle count can also be decorrelated from picking when the operator is required to perform a cycle count on a particular box or SKU not needed for picking and/or if there are no picking tasks that should be performed for a certain period of time, then the robots can bring the box/SKU to the picking station for cycle count. The warehouse maintenance refers to at least one of cleaning the warehouse, inspecting the condition of the warehouse's equipment, verifying the operation of the robots, unloading item containers from a truck etc. For example, the maintenance time of the robots, the time of swapping between the batteries, the charging time of their batteries if any, the waiting time on each robot path, as well as the time of a round trip for each robot according to the warehouse size may be considered. The space reduction task refers to a task during which the pick-up is proceeded from multiple item containers for the same order line in order to empty the warehouse. The space reduction task is time consuming and may be generally implemented when no time constraint exists. The space reduction task requires picker person(s) and robot(s) resources. For example, the data input utility 100A may receive that tomorrow, 1000 order lines should be treated on the same day before a cut-off time of e.g. 15:00. The recommendation optimization data may advise that it is preferable to achieve replenishment today. Additionally or alternatively, the recommendation optimization data may include daily planning with hourly operation. For example, the recommendation optimization data may propose to start with replenishment from 8:00 AM to 9:00 AM, to continue with picking from 9:00 AM to 11:00 AM, to perform consolidation from 11:00 AM to 12:00 AM and then to perform another session of picking with space reduction feature from 13:00 to 16:00.

For example, the data input utility 100A may receive that a certain number of item containers should be entered into the WCS. As described above with respect to FIG. 1, the recommendation optimization data may advise on the optimal resources (e.g. number of picking stations that should be opened and time to fulfill the replenishment together with the pick-up). Memory 100C may be integrated within task manager system 600 or may be an external storage device accessible by task manager system 600. The functionality of memory 100C is the same as described above with respect to FIG. 1. Task manager system 600 comprises at least one computer entity linked to a server via a network, wherein the network is configured to receive and respond to requests sent across the network, and also transmits one or more modules of computer executable program instructions and displayable data to the network connected user computer platform in response to a request, wherein the modules include modules configured to: receive and transmit order and time data, transmitting a recommendation optimization data, for display by the network connected user computer platform. The presently disclosed subject matter may include computer program instructions stored in the local storage that, when executed by task manager system 600, cause task manager system 600 to receive order data and time data and determine the recommendation optimization data. The computer program product may be stored on a tangible computer readable medium, comprising: a library of software modules which cause a computer executing them to prompt for information pertinent to a recommendation optimization data, and to store the information or to display recommendation optimization data. The computer program may be intended to be stored in memory 100C of task manager system 600, or in a removable memory medium adapted to cooperate with a reader of the task manager system 600, comprising instructions for implementing the method as will be described below. More specifically, the computer program may be in communication with an interface to receive order and time data.

In some embodiments, data input utility 100A may receive historical data being indicative of picking parameters such as averaged picked-up time per picker persons or per number of orders. In particular, different picker persons may have different pick-up time, and the different pick-up time of the different picker persons working at a specific time shift may be taken into consideration in real-time. For example, to be able to determine how many picker persons are required to fulfill a certain number of orders and if the working hours of a regular working day would be enough, the WCS may generate historical data, such as the averaged picked-up time per picker persons (or for a predetermined number of picker persons) for a predetermined number of orders, and calculate the optimized number of picker persons and/or picking time according to the number of received orders or predicted orders.

Additionally or alternatively, in some embodiments, order data may include predicting data being indicative predicted orders enabling to provide a recommendation optimization data being related to the special events. As defined below, special events are related to a significant increase in ordering of specific items in a specific period of time. In this connection, it should be understood that the special events may increase by a large factor (e.g. five) the number of orders treated during time periods outside these special events. For example, events such as black Friday typically multiplies by 4 to 5 the numbers of items to be shipped compared to a normal routine day. Normal routine days are typically defined as 85% of days of the year. The precise optimization of the different resources may be critical to appropriately handle the orders during these special events periods. The operator has several degrees of freedom (different tasks, different number of resources), however, without the recommendation optimization data of the task manager of the presently disclosed subject matter, he is not capable to appreciate whether he would be able to fulfill all the orders at the end of the requested time, when the pick-up time would finish and how the different resources should be distributed.

The optimization of a warehouse may include special planning in real-time of the warehouse (e.g. location of the items) according to the orders (amount and/or type of items) or to the predicted orders related to special events. The optimization of a warehouse may also include planning an optimized organization of the warehouse before special events. For example, consolidation and/or replenishment maintenance tasks may be programmed before Black Friday, or season changing (recall of the spring/summer items at the end of summer or recall of fall/winter items after the winter and restock with the new season).

The predicting data may be based on historical data predicting the special events or not. The prediction data includes at least one of the following: the timing of the special event(s), their expected duration, the item(s) related to these special events or their expected quantities. As mentioned above, the item containers holding specific items being related to the special events, may be displaced within the warehouse to be placed on storage casing(s) being closer to the picking stations to enable a shorter path to be run through for the robots.

In some embodiments, the predicting data may be calculated by the task manager of the present disclosure. The processing utility 100B may receive special events data being indicative of prediction of special events and/or historical data being indicative of the history of the orders to generate a recommendation optimization data being indicative of at least one predicted order being related to the special events. The recommendation optimization data relating to the treatment of the special events would probably increase the numbers of pickers, the time of picking and would probably anticipate the replenishment and would delay other maintenance tasks such as cycle count or consolidation.

In a specific and non-limiting example, the operator is aware that he received all the orders that should be fulfilled for tomorrow and that he would like to limit the shift working hours to eight hours. The task manager would advise that to fulfill all the orders, it should activate twenty robots on the thirty available robots and request for the presence of only five picker persons for pick-up on the seven picker persons available. Since ten robots and two picker persons are free, they can be attributed to perform maintenance tasks.

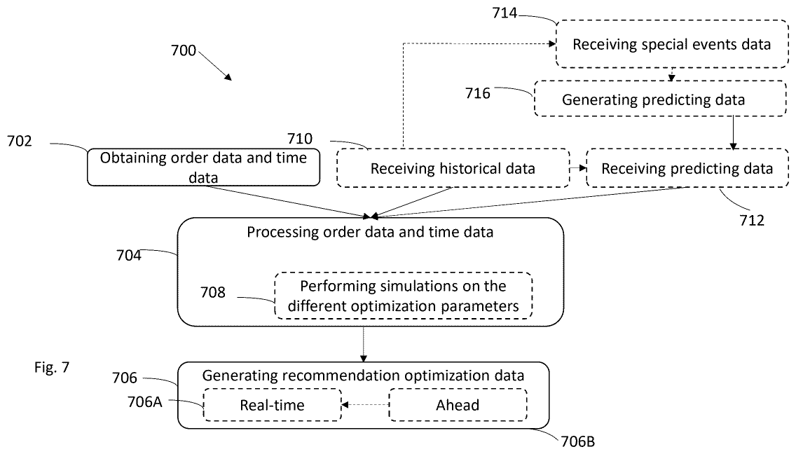

Reference is made to FIG. 7, showing a functional flow chart of a method for optimizing a warehouse management 700 of the presently disclosed subject matter. Method 700 comprises obtaining in 702 an order data being indicative of orders to be prepared using items from the warehouse and a time data being indicative of a predetermined period of time at which the preparation of the orders should be completed, processing in 704 the order and time data, and generating a recommendation optimization data in 706 comprising a plurality of optimization parameters being indicative of optimal resources that should be optimally attributed to complete at least one task including at least one of completion of the preparation of the orders and at least one maintenance task. Generating the recommendation optimization data may comprise generating the recommendation optimization data in real-time during the preparation of the orders in 706A or before the preparation of the orders in 706B including the day at which the orders are prepared or at least one day before the preparation of the orders. When the recommendation optimization data is generated before the preparation of the orders, the recommendation optimization data may comprise data being indicative of at least one of the followings: optimal location of selected items before or after pick-up, optimal time of operation of picking stations before and/or during the preparation of the orders, managing time of picker persons. In some embodiments, when the recommendation optimization data is generated before the preparation of the orders in 706B, the recommendation optimization data may be readjusted in real-time in function of the real accomplishment of the different tasks to fulfill all the orders. The readjustment may be due to different unexpected factors in real-time such as orders requiring immediate attention, delay in the picking up due to the picker persons, to a malfunction of a robot or unexpected peak of orders or picker persons having slower pick-up time . . . .

In some embodiments, the processing of the order and time data comprises performing in 708, a plurality of simulations on the plurality of the optimization parameters, to determine the optimal set of optimization parameters. The different simulations enable the operator to select the optimal set of the optimization parameters according to some other parameters not defined in the system.

Additionally to the order data and time data, historical data being indicative picking parameters of previous orders such as averaged picked-up time may also be considered in 710 to adjust the optimization parameters. Additionally or alternatively to the historical data, predicting data being indicative predicted orders may also be considered in 712 enabling to provide a recommendation optimization data being related to the special events. As mentioned above, predicting data may be based on historical data predicting the special events.

In some embodiments, prior to the processing of the order and time data in 704, the method may comprise in 714 receiving special events data being indicative of prediction of special events and/or historical data being indicative of the history of the orders to generate the predicting data in 716 being indicative of at least one of predicted orders being related to the special events. For example, the operator can inform the WCS on clearance sales on specific items, or seasonal sales.

Table 1 below shows a specific and non-limiting example of some possible recommendation optimization data being generated by the task manager system of the presently disclosed subject matter. As shown in the table, a set of different optimization parameters is proposed to the operator. This recommendation optimization data may be based on a specific number of orders already entered in the system, on an averaged number of orders, or on an expected number of orders (calculated by the system or not). In the first set, for one open picking station, it would take 16 hours to complete the orders, the time of the picker would be occupied at 95% and the robot would be occupied at picking up at 30%. Since the robot is not occupied enough, the task manager system would recommend performing at least one replenishment task to optimize the utilization of the robots. The number of boxes for which the replenishment task should be accomplished would be 157. In the second set, for two open picking stations, it would take 9 hours to complete the orders, the time of the picker would be occupied at 80% and the robot would be occupied at picking up at 60%. The task manager system would advise that there is no time for performing at least one replenishment task if new orders are entered into the system. In the third set, for three open picking stations, it would take 7 hours to complete the orders, the time of the picker would be occupied at 60% and the robot would be occupied at picking up at 90%. The task manager system would advise that there is no time for performing at least one replenishment task. The task manager system would advise, for the second and third set of optimizations that, the operator should renounce proceeding with a replenishment task or deciding to close a picking station and work two additional hours after picking to proceed with the replenishment.

TABLE 1

| Number of Picking Stations | 1 | 2 | 3 |
|---|---|---|---|
| Hours to finish | 16 | 9 | 7 |
| % occupancy of picker | 95 | 80 | 60 |
| % occupancy of robot fleet | 30 | 60 | 90 |
| for picking | | | |
| Recommendation | Do | No time if new orders | No time for |
| optimization data | replenishment | enter the system | replenishment |

| | | |
|---|---|---|
| How many boxes do you | 157 | You need to close a Picking Station to |
| need to replenish | | replenish and work 2 h more after picking |

The task manager system may also advise that, if a forecast of 1000 orders is suddenly expected or received, two more picking stations should be opened to complete the orders on time.

In some embodiments, as mentioned above, the task manager of the presently disclosed subject matter is capable of distributing the different resources between the different tasks optimally. Therefore, the set of the optimization parameters may be controlled by the operator. For example, the operator may decide that he is ready to reduce the picking efficiency by a certain percentage to increase the replenishment. Additionally or alternatively, the operator may also decide that he needs to reduce the picker throughput to perform maintenance tasks such as cycle count or consolidation. Additionally or alternatively, the operator may also decide that he prefers to bring a certain quantity of multiple boxes for one order line to empty boxes. Additionally or alternatively, he may also simulate how many orders can be completed if a replenishment is completed for 1000 orders, for a predetermined period of time. In each case described above, the task manager system is configured and operable to simulate operator's demands and to provide to the operator optimization parameters based on these specific demands/constraints and to distribute the tasks and/or the resources optimally. As described above, these simulations may be proceeded in real-time or by anticipation of forecast or real data. The simulations enable the operator to understand the impact of the attribution of the different number of resources. Moreover, the operator may also be able to control and change in real-time or by anticipation the different attributions of the resources of the system, to understand the impact of the attribution of the different number of resources.

1. A task manager system for a warehouse, said task manager system comprising:
an input data utility being configured and operable for receiving (i) at least one maintenance task to be performed in the warehouse, wherein the at least one maintenance task comprises at least one of replenishment, consolidation, cycle count, space reduction, warehouse maintenance, recall or replacement of batteries; (ii) a time data being indicative of a predetermined period of time at which the preparation of orders to be prepared using items from the warehouse should be completed, and (iii) warehouse resources to be attributed in the predetermined period of time including at least one of a predefined number of picking stations being associated with a certain number of picker persons and a predefined number of robots;
a processor being configured and operable for:
processing the time data by performing a plurality of simulations on a plurality of optimization parameters for the given time data, and generating a simulation data including a plurality of sets of optimization parameters, wherein the sets of optimization parameters include the warehouse resources and allocation of at least one maintenance task;
determining a selected set of optimization parameters based on the simulation data including the allocation of at least one maintenance task to be completed together with the preparation of the orders and an optimized attribution of the resources of the warehouse to thereby generate a recommendation optimization data regarding an optimization of a warehouse, wherein the recommendation optimization data comprises the selected set of optimization parameters, and an output data utility being configured and operable for provide the recommendation optimization data; wherein the recommendation optimization data enables to control and change in real-time or by anticipation the different attributions of the resources of the warehouse.

2. The task manager system of claim 1, wherein said selected set of optimization parameters further comprises at least one maintenance task parameter, wherein said at least one maintenance task parameter comprises at least one of a certain number of at least one of box and item to replenish, a number of cycle count, a number of consolidation and/or recall task.

3. The task manager system of claim 1, wherein said processor is configured and operable for receiving order data being indicative of the orders to be prepared using items from the warehouse.

4. The task manager system of claim 1, wherein the order data comprises at least one order line or recall data.

5. The task manager system of claim 4, wherein each order line comprises at least one order related parameter including an item identifier, a due date data for supplying the item and a quantity.

6. The task manager system of claim 5, wherein the due date data comprises an expected delivery due date and/or an indication for a prioritized handling.

7. (canceled)

8. The task manager system of claim 1, wherein the recommendation optimization data comprises a plurality of options, each option being indicative of a different optimization of the plurality of the optimization parameters.

9. The task manager system of claim 2, wherein said order data is received from a customer management system and said time data is received from an operator, the customer management system and the operator being in data communication of the processor.

10. (canceled)

11. The task manager system of claim 2, wherein the order data comprises predicting data being indicative of at least one of predicted orders enabling to provide a recommendation optimization data being related to special events.

12. (canceled)

13. A method for optimizing warehouse management, the method comprising obtaining, by at least one computerized system, (i) at least one maintenance task to be performed in the warehouse, wherein the at least one maintenance task comprises at least one of replenishment, consolidation, cycle count, space reduction, warehouse maintenance, recall or replacement of batteries; (ii) a time data being indicative of a predetermined period of time by which the preparation of commanded orders should be completed, and (iii) warehouse resources to be attributed in the predetermined period of time including at least one of: (1) a predefined number of picking stations; (2) a number of human pickers associated with each of the predefined stations and (3) a predefined number of robots; generating a plurality of optimization parameters comprising the warehouse resources and allocation of at least one maintenance task, the generating comprising performing a plurality of simulations using different resource attribution parameters; determining a selected set of optimization parameters based on the simulation data, the selected set of optimization parameters including (a) the allocation of at least one maintenance task to be completed together with the preparation of the commanded orders and (b) an optimized attribution of the resources of the warehouse, to thereby generate a recommendation optimization data regarding an optimization of a warehouse.

14. The method of claim 13, further comprising one or more of the following: receiving together with the time data an order data being indicative of orders to be prepared using items from the warehouse; receiving historical data being indicative picking parameters including averaged picked-up time; receiving a predicting data being indicative of at least one of predicted orders enabling to provide a recommendation optimization data being related to special events.

15. (canceled)

16. (canceled)

17. (canceled)

18. (canceled)

19. (canceled)

20. The method of claim 13, wherein the order data is received from a customer management system and said time data is received from an operator, the customer management system.

21. The method of claim 13, wherein generating the recommendation optimization data comprises generating the recommendation optimization data before the preparation of the orders including the day at which the orders are prepared or at least one day before the preparation of the orders or in real-time during the preparation of the orders.

22. (canceled)

23. (canceled)

24. (canceled)

25. At least one non-transitory computer readable medium that stores instructions that once executed by a computerized system causes the computerized system to execute a process for optimizing a warehouse management according to claim 13.

26. An automated warehouse that comprises:
a storage configured to store multiple items, wherein the multiple items are stored in item containers;
a plurality of picking stations that comprise at least one picking station;
one or more robots that are configured to convey item containers to the plurality of picking stations; and
the task manager system of claim 1.

27. An optimization system for use in automatic warehouses comprising: a plurality of independent management modules, wherein each management module is configured and operable to manage different warehouse tasks including at least one of items location or one or more optimization tasks and to generate a recommendation optimization data for a selected period of time comprising a plurality of optimization parameters; and a processing unit being configured and operable to control a-said plurality of independent management modules, providing prioritization between the independent management modules and an optimal operation of each management module in order to enable at least one of: maximal number of orders to be prepared per the selected time period, performing in the selected time period at least one maintenance task.

28. (canceled)

29. (canceled)

30. The optimization system of claim 28, wherein the processing unit is configured and operable to receive the recommendation optimization data generated by each independent management module to selectively operate one or more of the independent management modules, to optimize the timing of the different warehouse tasks and to provide an optimal recommendation optimization data of each independent management module taking into consideration the recommendation optimization data provided by the other management modules.

31. The optimization system of claim 28, wherein the plurality of independent management modules comprises at least two of the following modules: a mission planner management module configured and operable to process task data and generate based thereon recommendation optimization data being indicative of prioritization between the plurality of tasks to be performed: an order management module configured and operable to generate recommendation optimization data being indicative of prioritization between item containers to be moved to one or more picking stations based in accordance with a due time data: an inventory management module for processing at least one item container data and warehouse map data for generating a recommendation optimization data including an optimal location data being indicative of a specific optimal location at which the at least one item container is to be positioned on the storage: robot navigation management module configured and operable for receiving request data being indicative of a change of location of at least one robot and generating recommendation optimization data indicative of an optimal path for the at least one robot, wherein the optimal path includes at least one of a fastest path, shortest path, and most energy efficient path, and a task management module.

32. (canceled)

33. (canceled)

34. (canceled)

35. (canceled)

36. The optimization system of claim 31, wherein the optimal location data is determined in accordance with one or more location optimization parameters including at least one of location history data of items, weather, and accordingly temperature at different locations in the warehouse, or discounts on items.

37. The optimization system of claim 31, wherein the optimal location data comprises data being indicative of at least one of a proximity to a picking station or a height from the ground.

38. (canceled)

39. (canceled)

40. (canceled)

41. The optimization system of claim 27, wherein the processing unit is configured and operable to selectively operate the independent management modules by applying one or more optimization algorithms on the plurality of the optimization parameters including simulations on the plurality of the optimization parameters and applying different weights on each independent management module.

42. (canceled)

43. (canceled)

44. The optimization system of claim 41, wherein the processing unit is configured and operable to divide the selected time period into a plurality of sub-time periods, and wherein the applying of different weights on each independent management module comprising changing the different weights on each independent management module on each sub-time period.

45. The optimization system of claim 41, wherein the one or more optimization algorithms comprises clustering optimization, classification, artificial neural networks, deep neural network, reinforcement machine learning, or deep reinforcement learning in combination with minimization of a weighted cost function.

46. (canceled)

47. The optimization system of claim 27, wherein the processing unit is configured and operable to control the plurality of independent management modules in real-time to selectively operate an adequate management module performing the optimal warehouse task at the optimal time.

48. (canceled)

49. (canceled)

50. (canceled)

51. (canceled)

52. (canceled)

53. (canceled)

54. (canceled)

55. (canceled)

56. (canceled)
